(19) United States
(12) Patent Application Publication
(10) Pub. No.: US 2022/0211470 A1
(43) Pub. Date: Jul. 7, 2022

(54) REMOVABLE DENTAL APPLIANCES INCLUDING BENDABLE FLAPS AND ARCUATE MEMBERS

(71) Applicant: 3M INNOVATIVE PROPERTIES COMPANY, St. Paul, MN (US)

(72) Inventors: Richard E. Raby, Lino Lakes, MN (US); Eric S. Hansen, Apex, NC (US)

(21) Appl. No.: 17/601,106

(22) PCT Filed: Apr. 10, 2020
(86) PCT No.: PCT/IB2020/053428

§ 371 Date: Oct. 4, 2021

Related U.S. Application Data
(60) Provisional application No. 62/832,524, filed on Apr. 11, 2019.
(60) Provisional application No. 62/985,175, filed on Mar. 4, 2020.

(51) Int. Cl. A61C 7/08; A61C 7/00

(52) U.S. Cl. CPC A61C 7/08; A61C 7/002

(57) ABSTRACT

The invention relates to a removable dental appliance comprising an appliance body configured to at least partially surround a plurality of teeth of a patient. The appliance body defines a shell configured to receive a tooth of the plurality of teeth in an initial position and a bendable flap integrally formed with the appliance body to extend from a hinge axis of the shell. The bendable flap defines a boundary region extending from a first end of the hinge axis around the bendable flap to a second end of the hinge axis and including an arcuate member. In one specific embodiment, the arcuate member comprises a spring bellows extending away from a plane of the shell. The bendable flap and the arcuate member are configured to apply a force to the tooth to cause movement of the tooth toward a desired position when the removable dental appliance is worn by the patient.

### TECHNICAL FIELD

This disclosure relates to polymer-based removable dental appliances such as alignment trays.

### BACKGROUND

The field of orthodontics relates to repositioning teeth of a patient for improved function and aesthetic appearance. Orthodontic devices and treatment methods generally involve the application of forces to move teeth into a proper bite configuration, or occlusion. As one example, orthodontic treatment involves the use of slotted appliances, known as brackets, which are fixed to the patient's anterior, cuspid, and bicuspid teeth. An archwire is typically placed in the slot of each bracket and serves as a track to guide movement of the teeth to desired orientations. The ends of the archwire are usually received in appliances known as buccal tubes that are secured to the patient's molar teeth. Such dental appliances remain in the mouth of the patient and are periodically adjusted by an orthodontist to check the process and maintain the proper force levels on the teeth until proper alignment is achieved.

Orthodontic treatment may also involve the use of polymer-based tooth alignment trays, such as clear tray aligners (CTAs). For example, orthodontic treatment with CTAs includes forming a tray having shells that couple one or more teeth. Each shell is constructed in a position that is deformed from an initial position of a tooth, e.g., a maloccluded position. The deformed position of a respective shell of the CTA applies a force to a respective tooth toward a desired position for the tooth that is an intermediate position between the initial position and a final position resulting from the orthodontic treatment.

### SUMMARY

This disclosure describes removable dental appliances, such as aligner trays, that include at least one bendable flap integrally formed with an appliance body, and methods for making the same. The at least one bendable flap is configured to apply a force to a tooth to cause movement of the tooth toward a desired position when the removable dental appliance is worn by the patient.

In some examples, the disclosure describes a removable dental appliance that includes an appliance body configured to at least partially surround a plurality of teeth of a patient. The appliance body defines a shell configured to receive a tooth of the plurality of teeth in an initial position; and a bendable flap integrally formed with the appliance body to extend from a hinge axis of the shell. The bendable flap defines a flap boundary region extending from a first end of the hinge axis around the bendable flap to a second end of the hinge axis. The flap boundary region includes an arcuate member. The bendable flap and the arcuate member are configured to apply a force to the tooth to cause movement of the tooth toward a desired position when the removable dental appliance is worn by the patient.

In some examples, the disclosure describes a system including an ordered set of removable dental appliances configured to reposition one or more teeth of a patient. Each removable dental appliance in the set of removable dental appliances includes an appliance body configured to at least partially surround a plurality of teeth of a patient. The appliance body defines a shell configured to receive a tooth of the plurality of teeth in an initial position; and a bendable flap integrally formed with the appliance body to extend from a hinge axis of the shell. The bendable flap defines a flap boundary region extending from a first end of the hinge axis around the bendable flap to a second end of the hinge axis. The flap boundary region includes an arcuate member. The bendable flap and the arcuate member are configured to apply a force to the tooth to cause movement of the tooth toward a desired position when the removable dental appliance is worn by the patient.

In some examples, the disclosure describes a method that includes forming a model of dental anatomy of a patient; and forming, based on the model, a removable dental appliance. The removable dental appliance includes an appliance body configured to at least partially surround a plurality of teeth of a patient. The appliance body defines a shell configured to receive a tooth of the plurality of teeth in an initial position; and a bendable flap integrally formed with the appliance body to extend from a hinge axis of the shell. The bendable flap defines a flap boundary region extending from a first end of the hinge axis around the bendable flap to a second end of the hinge axis. The flap boundary region includes an arcuate member. The bendable flap and the arcuate member are configured to apply a force to the tooth to cause movement of the tooth toward a desired position when the removable dental appliance is worn by the patient.

In some examples, the disclosure describes a method that includes receiving, by a computing device, a digital representation of a three-dimensional (3D) dental anatomy of a patient, the dental anatomy providing initial positions of a plurality of teeth of the patient. The method also includes determining, by the computing device, dimensions and shapes of a removable dental appliance. The removable dental appliance includes an appliance body configured to at least partially surround a plurality of teeth of a patient. The appliance body defines a shell configured to receive a tooth of the plurality of teeth in an initial position; and a bendable flap integrally formed with the appliance body to extend from a hinge axis of the shell. The bendable flap defines a flap boundary region extending from a first end of the hinge axis around the bendable flap to a second end of the hinge axis. The flap boundary region includes an arcuate member. The bendable flap and the arcuate member are configured to apply a force to the tooth to cause movement of the tooth toward a desired position when the removable dental appliance is worn by the patient. The dimensions and shapes are configured to reposition the one or more teeth of the patient from an initial position to a desired position when the removable dental appliance is worn by the patient. The dimensions and shapes include a position, dimension, and shape of the shell; and a position, dimension, and shape of the bendable flap. The method also includes transmitting, by the computing device, a representation of the removable dental appliance to a computer-aided manufacturing system.

In some examples, the disclosure describes a non-transitory computer-readable storage medium that stores computer system-executable instructions that, when executed, configure a processor to receive, by a computing device, a digital representation of a three-dimensional (3D) dental anatomy of a patient, the dental anatomy providing initial positions of a plurality of teeth of the patient. The non-transitory computer-readable storage medium also stores computer system-executable instructions that, when executed, configure a processor to determine, by the computing device, dimensions and shapes of a removable dental appliance. The removable dental appliance includes an appliance body configured to at least partially surround a plurality of teeth of a patient. The appliance body defines a shell configured to receive a tooth of the plurality of teeth in an initial position; and a bendable flap integrally formed with the appliance body to extend from a hinge axis of the shell. The bendable flap defines a flap boundary region extending from a first end of the hinge axis around the bendable flap to a second end of the hinge axis. The flap boundary region includes an arcuate member. The bendable flap and the arcuate member are configured to apply a force to the tooth to cause movement of the tooth toward a desired position when the removable dental appliance is worn by the patient. The dimensions and shapes are configured to reposition the one or more teeth of the patient from an initial position to a desired position when the removable dental appliance is worn by the patient. The dimensions and shapes include a position, dimension, and shape of the shell; and a position, dimension, and shape of the bendable flap. The non-transitory computer-readable storage medium also stores computer system-executable instructions that, when executed, configure a processor to transmit, by the computing device, a representation of the removable dental appliance to a computer-aided manufacturing system.

In some examples, the disclosure describes a removable dental appliance including an appliance body configured to at least partially surround a plurality of teeth of a patient, the appliance body defining a shell configured to receive a tooth of the plurality of teeth in an initial position; and a force actuator integrally formed with the appliance body on the shell, where the force actuator defines a spiral configuration, and where the force actuator is configured to apply a force to the tooth to cause movement of the tooth toward a desired position when the removable dental appliance is worn by the patient.

The details of one or more examples of this disclosure are set forth in the accompanying drawings and the description below. Other features, objects, and advantages of this disclosure will be apparent from the description and drawings, and from the claims.

### BRIEF DESCRIPTION OF THE DRAWINGS

FIGS. 1A-1E illustrate facial, oblique, and mesial cross-sectional views of an example removable dental appliance that includes a shell and a bendable flap including an arcuate member configured to apply a force to a tooth of a patient.

FIGS. 2A and 2B are conceptual diagrams illustrating an example removable dental appliance that includes bendable flaps having a spiral configuration.

FIGS. 3A-3C are conceptual diagrams illustrating an example removable dental appliance that includes a bendable flap extending from a hinge axis and a spring bellows opposite the hinge axis.

FIGS. 4A-4C are conceptual diagrams illustrating an example removable dental appliance that includes a bendable flap extending from a slotted hinge axis and jumpers in a plane tangential to a surface of appliance body opposite the hinge axis.

FIGS. 5A and 5B are conceptual diagrams illustrating an example removable dental appliance that includes a bendable flap extending from a slotted hinge axis and a plurality of jumpers bridging flap boundary region in a plane tangential to a surface of appliance body opposite the hinge axis.

FIGS. 6A and 6B are conceptual diagrams illustrating an example removable dental appliance that includes a bendable flap extending from a hinge axis and a spring bellows extending around an entire flap boundary region.

FIGS. 7A and 7B are conceptual diagrams illustrating an example removable dental appliance that includes a bendable flap extending from a hinge axis and a plurality of jumpers bridging flap boundary region.

FIG. 8 illustrates a lingual view of an example removable dental appliance that includes a plurality of shells and a bendable flap configured to apply a force to a tooth of a patient.

FIGS. 9A-9C illustrate labial, lingual, and occlusal views of an example removable dental appliance that includes a shell and a plurality of bendable flaps configured to apply a force to a tooth of a patient.

FIG. 10 illustrates a lingual view of an example removable dental appliance that includes a plurality of shells and a plurality of bendable flaps configured to apply a force to a tooth of a patient.

FIG. 11 illustrates a lingual view of an example removable dental appliance that includes a shell and two bendable flaps configured to apply a force to a tooth of a patient.

FIG. 12 illustrates a lingual view of an example removable dental appliance that includes a shell and four bendable flaps configured to apply a force to a tooth of a patient.

FIGS. 13A-13F illustrate occlusal, lingual, and distal cross-sectional views of an example removable dental appliance that includes a shell and four bendable flaps configured to apply a force to a tooth of a patient.

FIG. 14 illustrates a buccal view of an example removable dental appliance that includes a shell and three bendable flaps configured to apply a force to a tooth of a patient.

FIGS. 15A and 15B illustrate buccal and occlusal views of an example removable dental appliance that includes a shell and two bendable flaps configured to apply a force to a tooth of a patient.

FIG. 16 illustrates a lingual view of an example removable dental appliance that includes a shell and bendable flap with a reinforcing structure configured to apply a force to a tooth of a patient.

FIG. 17 illustrates a lingual view of an example removable dental appliance that includes a shell and bendable flap with a reinforcing structure configured to apply a force to a tooth of a patient.

FIG. 18 is a block diagram illustrating an example computer environment in which a clinic and manufacturing facility communicate information throughout a dental appliance manufacturing process.

FIG. 19 is a flow diagram illustrating an example process of generating digital dental anatomy data.

FIG. 20 is a block diagram illustrating an example of a client computing device connected to a manufacturing facility via a network to generate digital dental anatomy data.

FIG. 21 is a block diagram illustrating an example computer-aided manufacturing system for construction of a removable dental appliance.

FIG. 22 is a flow diagram illustrating a process conducted at a manufacturing facility for construction of a set of removable dental appliances.

FIG. 23 is a flow diagram illustrating successive iterations of treatment using an ordered set of removable dental appliances.

### DETAILED DESCRIPTION

This disclosure describes removable dental appliances that include at least one bendable flap integrally formed with an appliance body to extend from a hinge axis of a shell and at least one arcuate member disposed in a respective flap boundary region between the shell and a respective bendable flap. Orthodontic treatment with the removable dental appliances includes the use of at least one bendable flap and at least one arcuate member in the flap boundary region to enable greater control of force vectors applied to the teeth of the patient. The bendable flap and arcuate member apply a force to a tooth to cause movement of the tooth toward a desired position when the removable dental appliance is worn by the patient. For example, a rest position of the bendable flap may intrude into a space defined by the desired position of the tooth. The shell may include a surface that defines a void internal to the shell and shaped to receive the tooth in the desired position. During use of the removable dental appliance, the bendable flap and arcuate member are displaced by the tooth into a deformed position to cause the force, while the surrounding shell remains substantially undeformed. The deformed bendable flap and arcuate member apply the force to a side of the tooth opposite from the void to cause movement of the tooth toward the void. In this way, the removable dental appliance including a bendable flap and arcuate member may be configured to concentrate deformation in at least one of the bendable flap, the hinge axis, or arcuate member.

By concentrating the deformation in at least one of the bendable flap, the hinge axis, or the arcuate member, the shell may remain more highly engaged with the tooth. For example, when the removable dental appliance is in a deformed state, e.g., worn by the patient, the shells may have more points of contact with a respective tooth, a greater surface area of contact on a respective tooth, or the like, compared to a removable dental appliance without a bendable flap. In this way, the removable dental appliance may improve engagement of the teeth in the shells, concentrate deformation in the bendable flap and arcuate member, or both. By separating the force generating member (e.g., the bendable flap and arcuate member) and the engagement member (e.g., the shell), the removable dental appliance enables greater control of forces applied to the teeth of a patient. In contrast, removable dental appliances that do not include at least one bendable flap and arcuate member, or other similar features, the appliance body both engages a respective tooth and creates the force required to move the tooth during the course of orthodontic treatment. The degree of tooth engagement (e.g., the amount and positions of shell/tooth contact) affects control of the force applied to the tooth.

The bendable flap and arcuate member are configured to control the magnitude, direction, and length of expression of the force applied to a respective tooth. For example, at least one of the position, shape, and dimensions of the bendable flap and/or the arcuate member may result in a desired force vector on the respective tooth. The force vector may be applied to the tooth in a direction or a magnitude that may not be possible to apply to the tooth without the bendable flap and arcuate member. The bendable flap and the arcuate member may also enable expression of a force over a greater distance than a removable dental appliance that relies on deformation of shells of the appliance to express force. For example, the rest position of the bendable flap may extend into a space defined by the tooth in the desired position of the tooth such that, as the tooth moves into a void shaped to receive the tooth in the desired position, the bendable flap continues to express the force of a sufficient magnitude to cause alveolar bone remodeling. Movement of the tooth results in partial relaxation of the bending moments of the bendable flap and/or arcuate member. Some residual stress may remain in the bendable flap and/or arcuate member to ensure positive force levels over the complete range of expression. In this way, the removable dental appliance may improve control of at least one of force vector direction, magnitude, or expression length, to achieve at least one of a desired tooth movement that may not be possible without the bendable flap, a desired tooth movement over a shortened treatment time, a desired tooth with fewer progressions of removable dental appliances in a set of removable dental appliances, or the like, compared to other orthodontic treatments.

In some examples, each removable dental appliance of an ordered set of removable dental appliances may result in a greater expression, e.g., compared to a removable dental appliance without bendable flaps and arcuate members, due to the net shape of the appliance remaining relatively constant over the course of each treatment stage. Because the bendable flaps and arcuate member may create force actuators that are isolated to individual teeth, only these focused portions of the appliance (the bendable flaps) need to deform in order to apply directed forces to the teeth. As such, all other portions of the appliance can be made fairly rigid, thereby providing guided channels for tooth movement as well as bracing to resist deformation where movement is not desired. The amount of expression achievable by a single removable dental appliance may be limited by the depth of each tooth-receiving void and the elastic limit of bending possible by each bendable flap. For example, the amount of expression may be greater than 0.25 millimeter (mm) of crown movement, such as greater than 0.5 mm of crown movement or greater than 1 mm of crown movement. When coupled with robust materials that maintain their aesthetics and mechanical properties over a longer in vivo period compared to commonly used thermoplastics, greater expression and control may reduce the number of removable dental appliances in an ordered set of removable dental appliances required to achieve a selected tooth movement, e.g., due to more expression per removable dental appliance; reduce the number of office visits, e.g., due to increased doctor confidence in treatment progress; reduce treatment duration, e.g., due to more continuous forces and decreased round-tripping; and enable more accurate finishes, e.g., due to higher appliance rigidity and positive force application over the complete range of motion.

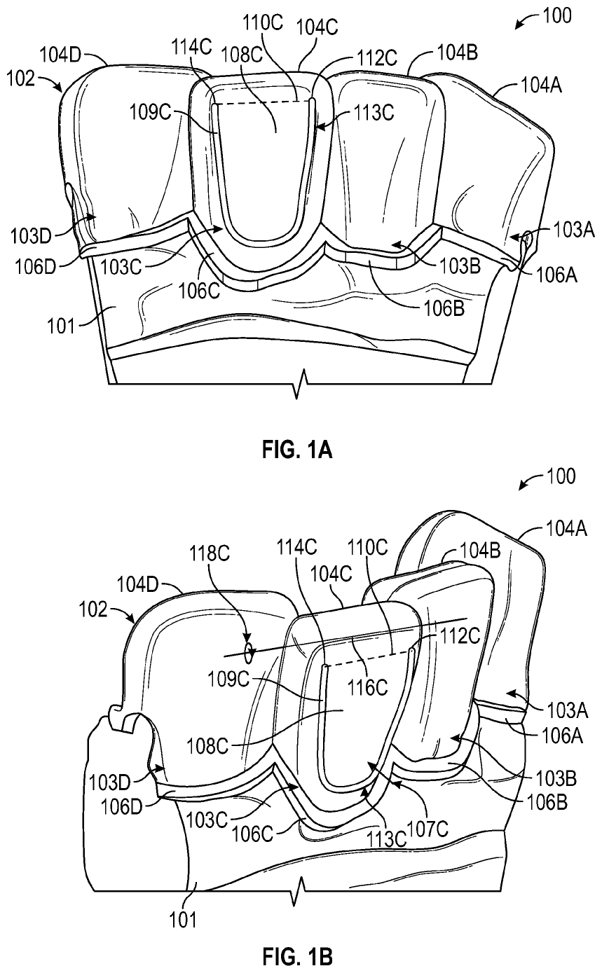

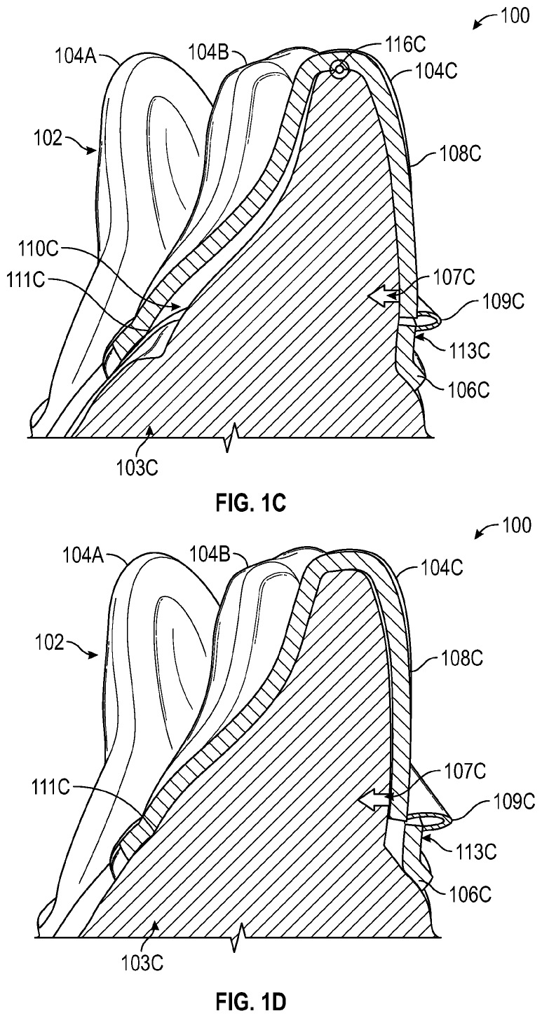

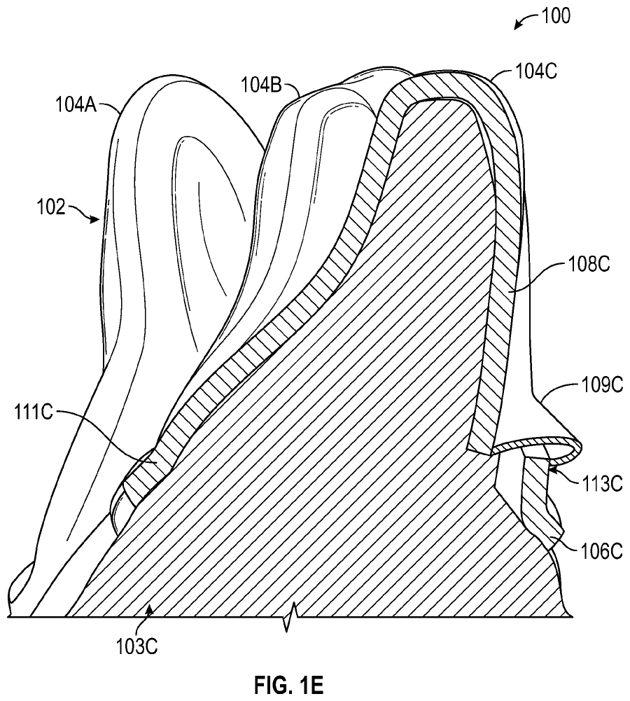

FIGS. 1A-1E illustrate facial, oblique facial, and mesial cross-sectional views of a portion of an example removable dental appliance 100 that includes a plurality of shells 104A-104D (collectively, “shells 104”), shell 104C including a bendable flap 108C and arcuate member 109C configured to apply a force 107C to a tooth 103C of a patient. Removable dental appliance 100 includes appliance body 102 configured to at least partially surround plurality of teeth 103A-103D (collectively, “teeth 103”) of the mandibular arch 101 of a patient. Appliance body 102 includes shells 104. Shells 104 may be configured to receive teeth 103. Bendable flap 108C and arcuate member 109C may be configured to apply force 107C to tooth 103C to cause a movement of tooth 103C toward a desired position of tooth 103C when removable dental appliance 100 is worn by the patient. The desired position may include an intermediate position between the initial position and the final position after orthodontic treatment.

In some examples, bendable flap 108C and arcuate member 109C may be configured to apply force 107C to an attachment on tooth 103C to cause a movement of tooth 103C toward the desired position. The attachment may include a natural undercut, such as, for example, a cusp tip, a cervical contour, or the like, an artificial undercut, a protrusion, a knob, a handle, or the like. By applying a force 107C to tooth 103C via bendable flap 108C and arcuate member 109C, removable dental appliance 100 may improve control of at least one of a force vector direction, magnitude, or expression length, to achieve at least one of a desired tooth movement that may not be possible without bendable flap 108C and arcuate member 109C, a desired tooth movement over a shortened treatment time, a desired tooth movement with fewer progressions of removable dental appliances in a set of removable dental appliances, or the like, compared to other orthodontic treatments.

For purposes of illustration, only teeth 103, shells 104, and bendable flap 108C are shown in FIGS. 1A-1E, although appliance body 102 may include any number of shells 104 configured to at least partially surround any number of teeth 103, any number of bendable flaps 108, and/or any number of arcuate members 109. For example, the number of teeth 103 on dental arch 101 may be fourteen, less than fourteen (e.g., a patient having one or more extracted teeth), or more than fourteen (e.g., a patient having wisdom teeth or hyperdontia). The number of shells 104 may be fourteen, less than fourteen (e.g., at least one shell configured to surround more than one tooth), or more than fourteen teeth (e.g., more than one shell portions configured to surround one tooth). Additionally, or alternatively, appliance body 102 may include a plurality of bendable flaps 108 on the same or difference shells 104. Additionally, or alternatively, one or more of each of bendable flaps 108 may include one or more arcuate members 109.

Appliance body 102 is configured to at least partially surround teeth 103 of either the maxillary dental arch or, as shown in FIGS. 1A-1E, the mandibular dental arch 101 of a patient. For example, appliance body 102 may surround at least one of the facial, lingual, and occlusal surfaces of teeth 103, overlap a portion of the gingiva of the patient, or the like. In some examples, appliance body 102 may surround different portions of different teeth 103.

Appliance body 102 includes shells 104. In some examples, appliance body 102 may include a respective shell of shells 104 for each respective tooth of teeth 103. In other examples, appliance body 102 may include fewer shells than teeth 103, e.g., shells may receive more than one tooth or a number of teeth 103 may not be surrounded by appliance body 102. In other examples, appliance body 102 may include more shells 104 than teeth 103, e.g., two or more shells 104 may surround at least a portion of at least one tooth of teeth 103. Each respective shell of shells 104 may be shaped to receive at least one respective tooth of teeth 103. In some examples, shells 104 may surround the facial, lingual, and occlusal portions of teeth 103. In other examples, shells 104 may surround fewer portions of teeth 103, such as, only the facial and lingual portions, or only one of the facial or lingual portions of teeth 103. For example, shells 104A, 104B, 104C, and 104D may be shaped to surround the lingual, occlusal, and facial portions of tooth 103A, 103B, 103C, and 103D, respectively. In some examples, shells 104 may define a plurality of voids. For example, appliance body 102 may define a framework configured to contact teeth 103 in selected locations. The selected location may include, for example, portions of interproximal regions between adjacent teeth, portions of occlusal surfaces of teeth, or portions of gingival margins of teeth. The framework may include material concentrated in areas or along lines as needed to resist deformation caused by internal stresses. These internal stresses come as a result of both applied forces and reaction forces acting on appliance body 102, where the applied forces are generally the result of elastic deformation in bendable flaps 108 as they contact the teeth, and the reaction forces are generally the result of other parts of appliance body 102 (e.g., shells 104) contacting tooth surfaces opposite the applied forces and their respective contact points. Key benefits to using a framework may include, for example, reduced material, reduced material cost, reduced fabrication time, increased aesthetics, and increased salivary flow. Such a framework also has the potential to be more rigid than an appliance having constant thickness, provided that increased thickness is used in areas where lines of force are concentrated to cause increased stress in the appliance material. As such, areas of material experiencing lower or minimal stress are removed. This is essentially the process of Generative Design, although it is typically iterative to evaluate stresses and refine the design after successive iterations until diminishing returns are achieved (a threshold is reached) in terms of optimization toward a particular goal, such as maximum rigidity, minimum volume, or a combination thereof. In this way, shells 104 may define a plurality of voids to define a framework contacting at least a portion of at least one of a first interproximal region mesial a respective tooth, a second interproximal region distal the respective tooth, an occlusal surface of the respective tooth, or a gingival margin of the respective tooth.

In some examples, a respective shell may not include a bendable flap (e.g., shells 104A, 104B, and 104D). In some examples, a respective shell may apply forces to respective received tooth by deformation of the respective shell. For example, when worn by the patient, shells 104A, 104B, and 104D may deform. The deformation may result in a restorative force as the respective shell moves toward an undeformed configuration. The restorative force may be transferred to the respective tooth via one or more points of contact between the respective shell and the respective tooth. In this way, removable dental appliance 100 may combine some shells 104 that include bendable flaps with some shells 104 that deform to move teeth 103 to desired positions of teeth 103. In other examples, a respective shell may be configured to be sufficiently stiff so as not to deform. A respective shell that does not deform may provide anchorage for neighboring shells, such as, for example, shells that include a bendable flap 108. The selection of which shells 104 include bendable flaps 108 may depend on the forces to be exerted on respective teeth 103, the movements of respective teeth 103, or both. For example, when deformation of a respective shell 104 does not interfere with the forces to be exerted on neighboring teeth 103 or the movements of neighboring teeth 103, the respective shell 104 may not include a bendable flap 108. Conversely, when deformation of a respective shell 104 does interfere with the forces to be exerted on neighboring teeth 103 or the movements of neighboring teeth 103, the respective shell 104 may include a bendable flap 108 to reduce deformation of the respective shell 104.

In some examples, appliance body 102 may include one or more anchor shells configured to receive one or more anchor teeth. In some examples, anchor teeth may include one or more molar teeth, premolar teeth, or both. In other examples, anchor teeth may include one or more anterior teeth, or a combination of one or more anterior and posterior teeth. Anchor shells may be configured to allow appliance body 102 to deform to result in a force sufficient to move (e.g., force sufficient to cause alveolar bone remodeling) selected teeth without resulting in sufficient force to move the respective anchor teeth.

Shell 104C may be shaped to engage tooth 103C in an initial position of tooth 103C. To engage an initial position of tooth 103C, an internal surface of shell 104C may contact an at least one selected location, a selected surface area, or both of tooth 103C. For example, as shown in FIG. 1C, surface 111C of shell 104C may contact at least a portion of an occlusal surface and a lingual surface of tooth 103C in an initial position. The locations of contact, surface area of contact, or both may affect force 107C applied by bendable flap 108C to tooth 103C, the resulting movement of tooth 103C, or both.

Shell 104C may also be shaped to receive tooth 103C in a desired position of tooth 103C. The desired position of tooth 103C may be the position after force 107C has been exerted on tooth 103C to move tooth 103C to the extent possible in shell 104C. For example, surface 111C may define void 110C internal to shell 104C. As shown in FIG. 1C, void 110C includes a wedge-shaped void with a maximum depth near the gingival margin of tooth 103C that tapers to a minimum near axis of rotation 116C at the incisal edge of tooth 103C. The wedge shape of void 110C may be congruent with the path of tooth 103C as tooth 103C moves toward the desired position defined by surface 111C. Tooth 103C may move through void 110C toward the desired position until tooth 103C contacts surface 111C. In this way, surface 111C may prevent tooth 103C from moving beyond the desired position.

Removable dental appliance 100 includes at least one bendable flap 108C. In general, any number of bendable flaps may be positioned on any number of shells 104. Bendable flap 108C may be integrally formed with shell 104C of appliance body 102 to extend from hinge axis 110C. Hinge axis 110C extends along an incisal edge of shell 104C in the mesio-distal direction. Generally, a respective bendable flap 108 may extend from a respective hinge 110 axis extending along any portion of a respective shell, in any direction. By selecting a length and an orientation of a respective hinge axis 110, removable dental appliance 100 may be configured to apply a respective force via a respective bendable flap 108 to any portion of a respective tooth.

As shown in FIGS. 1A-1E, bendable flap 108C extends from hinge axis 110C on a facial surface of appliance body 102 and is positioned on a facial side of removable dental appliance 100. Appliance body 102 defines a flap boundary region 113C extending from first end 114C around bendable flap 108C to second end 112C. Flap boundary region 113C may include an area of reduced shear and tensile stress compared to surrounding portions of appliance body 102. For example, at least a portion of flap boundary region 113C includes arcuate member 109C.

Arcuate member 109C may increase the flexibility of appliance body 102 at flap boundary region 113C compared to the surrounding appliance body 102. As illustrated in FIGS. 1A-1E, arcuate member 109C may include a spring bellows (e.g., a ribbon of material) extending around at least a portion of flap boundary region 113C and coupled to shell 104C and bendable flap 108C. In some examples, arcuate member 109C may include a plurality of spring bellows. In other examples, arcuate member 109C may include one or more jumpers (e.g., a rod of material) defining an arc in a plane tangential to the surface of shell 104C or extending outside of the plane tangential to the surface of shell 104C and coupled to shell 104C and bendable flap 108C. In some examples, arcuate member 109C may include any suitable combination of one or more spring bellows, one or more jumpers, or one or more shear reduction regions.

Arcuate member 109C may have an arcuate, sinusoidal, zig-zag, pulsing wave, spiral, helix, serpentine, or folded cross-section in a plane tangential to the surface of shell 104C and/or a plane perpendicular to the plane tangential to the surface of shell 104C. The position (e.g., relative to shell 104C and bendable flap 108C) and shape of arcuate member 109C may be selected to allow for cantilever motion of bendable flap 108C and application of a selected force 107C to tooth 103C via bendable flap 108C when removable dental appliance 100 is worn by the patient.

In some examples, arcuate member 109C may be made of the same material as shell 104C. For example, arcuate member 109C may be formed integrally with shell 104C. In some examples, arcuate member 109C may be formed by laser cutting portions of appliance body 102 to define arcuate members 109C. Additionally, or alternatively, arcuate member 109C may be formed by remolding (e.g., heating and applying a force) portions of appliance body 102, or coupling additional material to a surface of appliance body 102 (e.g., by adhesion, thermo welding, ultrasonic welding, or the like) to define arcuate members 109C. In some examples, at least a portion of arcuate member 109C may be thinner than shell 104C to allow for greater flexibility, for example, of the spring bellows or the jumper. In some examples, at least a portion of arcuate member 109C may be thicker than shell 104C to allow for greater rigidity or toughness of the spring bellows or the jumper. In some examples, arcuate member 109C may include different or additional material, such as materials having a higher modulus relative to the material of appliance body 102, metals (wires, ribbons, or sheets), or the like. The materials and manufacture of arcuate member 109C may be selected to allow for cantilever motion of bendable flap 108C and application of a selected force 107C to tooth 103C via bendable flap 108C when removable dental appliance 100 is worn by the patient.

In examples in which arcuate member 109C includes a spring bellows, the spring bellows may include a continuous or discontinuous curvilinear portion of appliance body 102, e.g., an arc, a half wave, a full wave shape, zig-zag, sinusoid, a pulsed wave, or serpentine shape. In some examples, the arcuate displacement may include at least one fold to increase the length and/or flexibility of the spring bellows. The length of the spring bellows may be selected to provide a selected force resulting from the deformation of the spring bellows when removable dental appliance 100 is worn by the patient.

In examples in which the spring bellows includes a continuous curve, the arcuate displacement may define an outer radius of curvature, e.g., an outermost surface of the spring bellows. In some examples, the outer radius of curvature may be between about 0.5 millimeters and about 3 millimeters, or about 0.75 millimeters and about 1.5 millimeters, or about 1.0 millimeters. The radius of curvature may be substantially constant or may vary along an interproximal boundary curve. The spring bellows also may define a displacement distance extending between a midline of flap boundary region 113C and a midline of the spring bellows. In some examples, the displacement distance may be less than about 3 millimeters, or less than about 1 millimeter, or less than about 0.75 millimeters, or about 0.5 millimeters. The displacement distance may be substantially constant or may vary along flap boundary region 113C.

A thickness of the spring bellows may be less than a thickness of shell 104C and bendable flap 108C such that the spring bellows deforms more than shell 104C and bendable flap 108C to concentrate compression, tension, shear, bending, or torsion in the spring bellows. The thickness of the spring bellows may be between about 0.025 millimeters and about 1.0 millimeter, or between about 0.1 millimeters and about 0.75 millimeters, or between about 0.15 and about 0.6 millimeters, or about 0.3 millimeters. The thickness of the spring bellows may be substantially constant or vary along flap boundary region 113C.

In some examples, the spring bellows may define at least one shear reduction region, e.g., at least one void or cutout in the spring bellows. The at least one shear reduction region may concentrate deformation of spring bellows 108 in selected portions of spring bellows 108. The location of the terminations of the spring bellows on the shell 104C and bendable flap 108C may be selected to provide a selected direction and magnitude of force when removable dental appliance 100 is worn by the patient. In some examples, arcuate member 109C may include a plurality of spring bellows, each respective spring bellows of the plurality of spring bellows disposed along a respective portion of the flap boundary region.

By selecting the shape, length, radius of curvature, and displacement distance of spring bellows, removable dental appliance 100 may control at least one of a direction, a magnitude, and a length of expression of a force on bendable flap 108 resulting from deformation of appliance body 102 when removable dental appliance 100 is worn by the patient. Other spring bellows configurations are described in U.S. Patent Application No. 62/568,982, by Raby, et al., which is incorporated herein by reference in its entirety.

In examples in which arcuate member 109C includes a jumper, the jumpers include an elongate structure extending along a longitudinal axis between a first end coupled to any suitable portion of shell 104C or a different shell 104 (e.g., not directly adjacent to bendable flap 108C) and a second end coupled to any suitable portion of bendable flap 108C. At least a portion of force 107C results from a deformation of the jumper when removable dental appliance 100 is worn by the patient. For example, when removable dental appliance 100 is worn by the patient, the jumpers may deform to exert at least one of a bending force, a twisting force, a compressive force, a tensile force, or a shear force on the first end and the second end such that selection of the location of the first and second ends may control the direction and magnitude of force 107C.

The jumper may include any suitable shape along the longitudinal axis of the elongate structure, such as, for example, at least one of an arc, fold, zig-zag, sinusoid, spiral, helix, or serpentine shape extending between the first end and the second end of the jumper. In some examples, elongated structure may include at least one fold. In some examples, a medial portion of the jumper (e.g., between the first end and second end) may extend away from a plane tangential to a surface of shell 104C. In other examples, the medial portion of the jumper may be substantially in the plane tangential to a surface of shell 104C (e.g., deviate from the plane by less than about 0.5 mm).

In some examples, the jumper may include an arcuate shape having an outer radius of curvature (e.g., outermost surface of the jumper) between about 0.5 millimeters and about 5 millimeters. In some examples, the jumper may include a displacement distance (e.g., distance between a plane tangential to a surface of shell 104C and a midline of the inner radius of the jumper) less than about 2 millimeters, or less than about 1 millimeter, or less than about 0.5 millimeters, or about 0.5 millimeters. The jumper may define a cross-section in a plane perpendicular to a longitudinal axis of the elongated structure having any suitable shape, area, or aspect ratio selected to provide a selected force bendable flap 108C. The shape, area, or aspect ratio of the cross-section may be constant or vary along the longitudinal axis.

The jumper may include any suitable thickness selected to control the magnitude and direction, or the location of concentration, of force 107C resulting from deformation of appliance body 102 when removable dental appliance 100 is worn by the patient. In some examples, the jumper may be more flexible than the shell to at least one of reduce deformation of the shell or concentrate stress in the jumper when the removable dental appliance is worn by the patient. In some examples, a thickness of appliance body 102 increases near at least one of the first end or the second end of the jumper, for example, to improve toughness of the intersection of the first and second ends and appliance body 102. A thickness of the jumper may be substantially constant or may vary along elongated structure in a tapered or stepwise manner. In some examples, the thickness of the jumpers may be between about 0.1 millimeters and about 3.0 millimeters, or about 0.3 millimeters and about 1.0 millimeter.

In some examples, the appliance body may include a gingival portion coupled to the second end of the jumper (the first end being coupled to bendable flap 108C) to at least partially anchor appliance body 102 to the alveolar process via the gingiva. In some examples, arcuate member 109C may include a plurality of jumpers, each respective jumper of the plurality of jumpers including a respective elongated structure extending between a respective first end coupled to a respective position on the shell and a respective second end coupled to a respective position on the bendable flap.

By selecting the shape, length, radius of curvature, and displacement distance of jumpers, removable dental appliance 100 may control at least one of a direction, a magnitude, and a length of expression of a force on bendable flap 108 resulting from deformation of appliance body 102 when removable dental appliance 100 is worn by the patient. Other jumper configurations are described in U.S. Patent Application No. 62/569,144, by Raby, et al., which is incorporated herein by reference in its entirety.

In some examples, arcuate member 109C may result in at least a portion of force 107C, bendable flap 108C may remain relatively unbent in the deformed portion, or both. Arcuate member 109C may at least one of enable increased surface contact of bendable flap 108C with tooth 103C, reduce build-up of food particles or plaque in flap boundary region 113C or other portions of the appliance body 102, and reduce conflict between the bendable flap 108C and the dental anatomy of the patient, when removable dental appliance 100 is worn by the patient or fitted to the teeth.

In some examples, shell 104C may be thinner or include one or more voids along hinge axis 110C. The thinner material or voids along hinge axis 110C may relieve bending stresses in bendable flap 108C. In some examples, at least a portion of flap boundary region 113C also may define one or more cutouts or slits in appliance body 102. Removal of the material from flap boundary region 113C may effectively nullify shear and tensile stress in flap boundary region 113C. Additionally or alternatively, at least a portion of flap boundary region 113C may include an elastomeric polymer or material with a lower elastic modulus than appliance body 102, an area of reduced thickness of appliance body 102, or the like, to increase the flexibility of flap boundary region 113C compared to the surrounding appliance body 102. In this way, flap boundary region 113C may allow bendable flap 108C to deflect in the lingual-facial direction, reduce the amount of deformation in bendable flap 108C to increase contact area of the number of contacts between bendable flap 108C and tooth 103C, or both to improve control over tooth movement. In examples in which flap boundary region 113C includes an elastomeric material, the elastomeric material may be selected to allow bendable flap 108C to deflect in the facial-lingual direction, cover at least a portion of flap boundary region 113C to reduce build-up of food particles or plaque in flap boundary region 113C or other portions of the appliance body 102, or both.

Bendable flap 108C and arcuate member 109C may be configured to apply force 107C to a facial surface of tooth 103C. For example, a rest position of bendable flap 108C may intrude into a space defined by tooth 103C in a desired position of tooth 103C such that when removable dental appliance 100 is worn by the patient, an initial position of tooth 103C may cause a deformation of bendable flap 108C and arcuate member 109C. The deformation of bendable flap 108C and arcuate member 109C may result in force 107C, e.g., a restorative force as bendable flap 108C and arcuate member 109C move toward an undeformed configuration. The rest position of bendable flap 108C and arcuate member 109C may be selected to reduce conflict with the incisal edge of tooth 103C when removable dental appliance 100 is fitted to the teeth. Additionally or alternatively, bendable flap 108C may include a ramped surface near a gingival portion of bendable flap 108C such that the ramped surface deflects bendable flap 108C and arcuate member 109C or otherwise reduces conflict with the incisal edge of tooth 103C when removable dental appliance 100 is fitted to the teeth.

In response to force 107C, tooth 103C may move through void 110C toward the desired position until tooth 103C contacts surface 111C. In some examples, if only a portion of tooth 103C contacts surface 111C, while gaps remain elsewhere, a couple may be formed between the contact point and force 107C. The resulting couple may cause tooth 103C to move, e.g., to “walk,” into a position of greater alignment with surface 111C. For example, tooth 103C may move in stages of alternating translation and rotation, until tooth 103C is received in a position of substantial conformity with surface 111C. In some examples, surface 111C may be positioned beyond the desired position of tooth 103C to compensate for relapse of tooth 103C back toward an intermediate position or the initial position of tooth 103C. In this way, selecting the shape of internal surface of shell 104C may enable control of the locations of a force and resulting movement of tooth 103C. Similar effects are also possible for shells 104A, 104B, and 104D.

Force 107C may be transferred from bendable flap 108C and arcuate member 109C to tooth 103C by one or more contact points of bendable flap 108C with tooth 103C. For example, an interior surface of bendable flap 108C may contact at least a portion tooth 103C. In some examples, the interior surface of bendable flap 108C may be shaped to conform to a shape of tooth 103C in a desired position of tooth 103C such that contact between bendable flap 108C and tooth 103C is increased as tooth 103C moves toward the desired position. In some examples, the thickness of bendable flap 108C may be selected to control the number or location of contact points. In some examples, bendable flap 108C may be divided (e.g., by laser cutting) into a plurality of flaps control the number or location of contact points. In other examples, bendable flap 108C may include at least one protrusion on an interior surface of bendable flap 108C. The protrusion may be positioned or shaped to transfer force 107C to at least one selected portion of tooth 103C. For example, bendable flap 108C may include at least one protrusion near the gingival portion of bendable flap 108C such that the transfer of force 107C to tooth 103C is concentrated near the gingival margin. By concentrating the transfer of force near the gingival margin, bendable flap 108C may more effectively cause a torqueing or root tipping of tooth 103C. In this way, protrusions on respective bendable flaps may be used to control the transfer of a respective force to achieve or increase the effectiveness of tooth movements, such as, for example, translation, rotation, tipping, torqueing, extrusion, intrusion, or combinations thereof.

In some examples, as shown in FIG. 1C, when removable dental appliance 100 is worn by the patient, axis of rotation 116C may be substantially fixed or anchored through appliance body 102 to other parts of the dental anatomy, such as, for example, teeth 103A, 103B, and 103D. Application of force 107C to a portion of tooth 103C near the gingival margin by bendable flap 108C and arcuate member 109C may form a couple with axis of rotation 116C. A couple may include two opposing forces offset by some distance. For example, as force 107C moves tooth 103C with a center of resistance located near the center of the root of tooth 103C, the fixed axis of rotation 116C of shell 104C may apply a second opposing force to the incisal edge of tooth 103C. By forming a couple with axis of rotation 116C, force 107C may result in rotation 118C of tooth 103C toward void 110C, e.g., a root tipping or torqueing movement. In this way, the locations of contact, surface area of contact, or both of surface 111C of shell 104C may affect force 107C applied to tooth 103C, the resulting movement of tooth 103C, or both.

When removable dental appliance 100 is fitted to, or removed from, teeth 103, bendable flap 108C and arcuate member 109C may deflect in the lingual-facial direction as bendable flap 108C and arcuate member 109C deforms to accommodate tooth 103C. The deflection may cause stress near first and second ends 114C and 112C of hinge axis 110C, and/or where arcuate member 109C is coupled to shell 104C and bendable flap 108C. To reduce stress caused by deflection of bendable flap 108C and/or arcuate member 109C, appliance body 102 may define stress concentration reduction regions. The circular stress concentration reduction regions may include a diameter that is at least greater than a width of flap boundary region 113C. As bendable flap 108C and arcuate member 109C deflect, stress may be distributed around the circular stress concentration reduction region to reduce localized concentration of stress that may otherwise tear appliance body 102 or cause wearing of appliance body 102. Reducing localized concentration of stress may reduce wear on appliance body 102 and increase the useable life of removable dental appliance 100.

By allowing deflection of bendable flap 108C in the lingual-facial direction, bendable flap 108C and arcuate member 109C may be configured to apply force 107C to a side of tooth 103C opposite from void 110C to cause movement of tooth 103C toward void 110C. For example, bendable flap 108C may be configured to intrude into a space defined by the desired position of tooth 103C when bendable flap 108C is in a rest position. In some examples, the desired position of tooth 103C is a position after tooth 103C contacts at least a portion of the surface of appliance body 102 defining void 110C internal to shell 104C. As shown in FIG. 1E, bendable flap 108C intrudes into the space defined by tooth 103C. By intruding into the space defined by tooth 103C in the desired position, bendable flap 108C and arcuate member 109C may apply force 107C to tooth 103C through the movement of tooth 103C into void 110C. For example, as illustrated in FIG. 1C, bendable flap 108C and arcuate member 109C may apply force 107C to tooth 103C when tooth 103C is in an initial position. As seen in FIG. 1D, bendable flap 108C and arcuate member 109C applies force 107C to tooth 103C when tooth 103C is in the desired position. When tooth 103C is in the desired position, force 107C may be greater than a minimum force to cause alveolar bone remodeling. In this way, removable dental appliance 100 may achieve complete expression of tooth 103C through void 110C to a position of substantial conformity with surface 111.

In some examples, appliance body 102 may include gingival regions 106A, 106B, 106C, and 106D (collectively, “gingival regions 106”) that overlap at least a portion of the gingiva (e.g., gingival margins) of the patient. For example, gingival regions may extend around the gingival portion of shells 104, where teeth 103 meets the gingiva. Gingival regions 106 may be configured to use at least a portion of the gingiva, the alveolar process, or both for anchorage. For example, when worn by the patient, gingival regions 106 may at least partially contact the gingiva to access additional bracing provided by gingival regions 106 indirectly engaging with the alveolar process without impeding mobility of teeth 103. Additionally, or alternatively, by increasing an extent of shells 104 with gingival regions 106, greater force may be applied to a selected tooth of teeth 103 while using the more rigid alveolar process as an anchor instead of neighboring teeth. As such, gingival regions 106 may allow better control of tooth movements relative to a fixed reference (the alveolar process), without causing unwanted reactionary movements of neighboring teeth. In some examples, appliance body 102 may exclude gingival regions 106.

In some examples, appliance body 102 may include a unitary material, e.g., a single, uniform material. The unitary material may include a single polymer, or homogeneous mixture of one or more polymers. For example, removable dental appliance 100 may consist of a single, continuous 3D printed or thermoformed component. In other examples, appliance body 102 may include a multi-layer material. Multi-layer materials may enable one or more portions of appliance body 102 to be formed with a plurality of layers having different elastic modulus to enable selection of force characteristics, displacement characteristics, or both of bendable flap 108C. The multi-layer material may include multiple layers of a single material, e.g., a single polymer, or multiple layers of a plurality of materials, e.g., two or more polymers, a polymer and another material. For example, removable dental appliance 100 may consist of a multilayer 3D printed or thermoformed component. Suitable polymers may include, but are not limited to, (meth)acrylate polymer; epoxy; silicones; polyesters; polyurethanes; polycarbonate; thiol-ene polymers; acrylate polymers such as urethane (meth)acrylate polymers, polyalkylene oxide di(meth)acrylate, alkane diol di(meth)acrylate, aliphatic (meth)acrylates, silicone (meth)acrylate; polyethylene terephthalate based polymers such as polyethylene terephthalate glycol (PETG); polypropylene; ethylene-vinyl acetate; or the like. The thickness of appliance body 102 may range between about 0.10 millimeters and about 2.0 millimeters, such as between about 0.2 and about 1.0 millimeters, or between about 0.3 millimeters and about 0.75 millimeters. In the same or different examples, removable dental appliance 100 may include chamfers or fillets on edges of appliance body 102 and other spaces. Such chamfers or fillets may improve patient comfort and reduce the visibility of removable dental appliance 100. In the same or different examples, removable dental appliance 100 may include at least one reinforcement structure to increase the stiffness of an area of appliance body 102 (e.g., bendable flap 108C or arcuate member 109C) to increase the strength of an area of appliance body 102 (e.g., hinge axis 110C).

In some examples, removable dental appliance 100 may include metallic components configured to enhance forces applied by removable dental appliance 100 to one or more of the surrounded teeth. For example, the metallic component may comprise a metal wire having any suitable cross sectional shape (e.g., circular, rectilinear, or a ribbon) extending through at least a portion of appliance body 102, such as bendable flap 108C or arcuate member 109C. In some examples, removable dental appliance 100 may include one or more other metal components, such as metal occlusal components, where greater durability is needed to overcome the stress of high-pressure occlusal contact, such as caused by bruxing, or mastication. In some examples, removable dental appliance 100 may include catches to connect to an anchorage device implanted within the patient, e.g., a temporary anchorage device or mini-screw. For example, catches may be positioned on anchor shells to connect to an anchorage device on anchor teeth. In this manner, such removable dental appliances 100 may provide a hybrid construction of metal and plastic. While plastic components may be generally clear for reduced visibility, metal components may include plating or other coloring to reduce visibility of removable dental appliance 100 when worn by the patient. For example, metal components positioned near teeth 103 of a patient when worn may include white colored coating or plating, such as, for example, rhodium, silver, white anodized titanium, Teflon, PTFE, and the like, or be formed of a white colored metal, such as, for example, rhodium, silver, white anodized titanium, and the like. Metal components positioned elsewhere may be colored to generally match tissue color within the mouth of the patient.

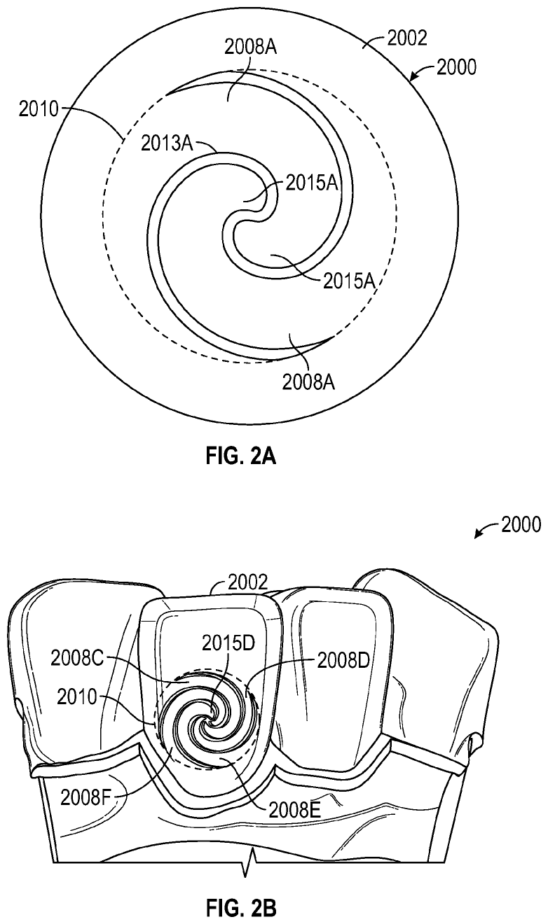

In some examples, a respective bendable flap or plurality of bendable flaps may define a spiral configuration. FIGS. 2A-2C are conceptual diagrams illustrating an example removable dental appliance 2000 that includes bendable flaps 2008 having a spiral configuration. Removable dental appliance 2000 may be the same as or substantially similar to removable dental appliance 100 discussed above in reference to FIGS. 1A-1E, except for the differences describe herein.

The spiral configuration of bendable flaps 2008 may enable a bendable flap (or a plurality of bendable flaps) to apply a force near a center of the spiral and distribute a corresponding deformation around a perimeter of the spiral. For example, as illustrated in FIG. 2A, appliance body 2002 may include two bendable flaps 2008A defining a single flap boundary region 2013A defining a double spiral configuration. When in a rest position, centers 2015A of bendable flaps 2008A may intrude into a space defined by a desired position of a tooth. In a deformed position, when worn by a patient, bendable flaps 2008A may deform to concentrate a deformation force on the tooth near centers 2015A. The deformation force of bendable flaps 2008A may be transferred to appliance body 2002 around a perimeter 2010 of the spiral configuration. In some examples, as illustrated in FIG. 2B, the spiral configuration may include a quadruple spiral configuration having a plurality of bendable flaps 2008C, 2008D, 2008E, 2008F. In some examples, removable dental appliance 2000 may include arcuate members as discussed above in reference to FIGS. 1A-1E.

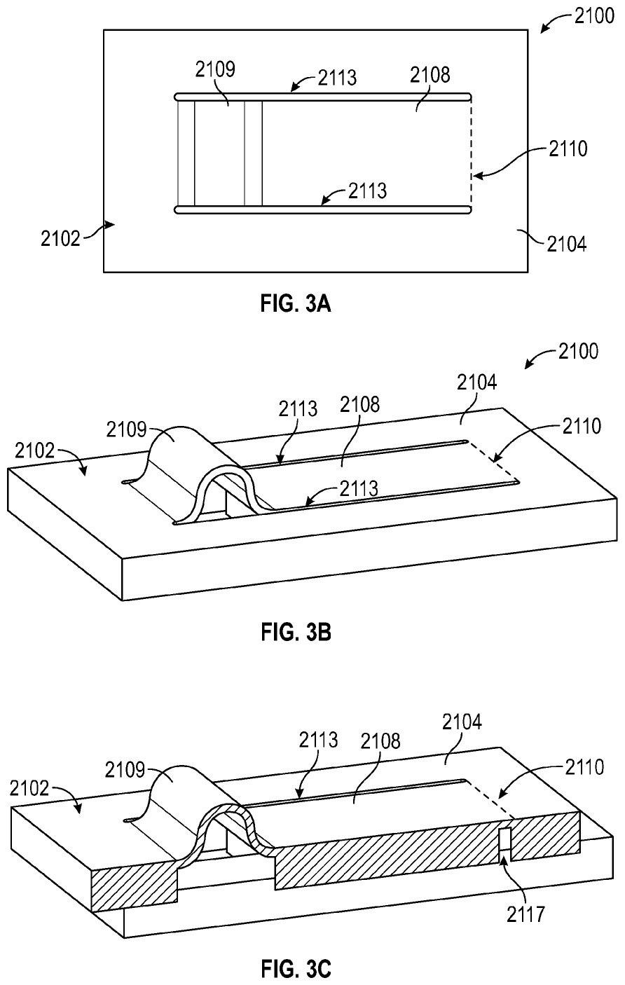

In some examples, a respective bendable flap may define slotted edges, have thinner material along a hinge axis, and thinner material defining an arcuate member opposite the hinge axis. FIGS. 3A-3C are conceptual diagrams illustrating an example removable dental appliance 2100 that includes a bendable flap 2108 extending from a hinge axis 2110 and a spring bellows 2109 opposite hinge axis 2110. Removable dental appliance 2100 may be the same as or substantially similar to removable dental appliance 100 discussed above in reference to FIGS. 1A-1E, except for the differences describe herein.

As illustrated in FIGS. 3A-3C, bendable flap 2108 extends from appliance body 2102 at hinge axis 2110. Hinge axis 2110 may include voids 2117 defining a thinner region of appliance body 2102. In some examples, voids 2117 may include a series of notches to form a living hinge that may act more a compliant mechanism than an energy storage member. Bendable flap 2108 defines slotted sides 2113. Slotted sides 2113 may include apertures extending through appliance body 2102. In other examples, slotted sides 2113 may include any suitable type of area of reduced shear resistance compared to adjacent portions of appliance body 2102. Appliance body 2102 includes arcuate member 2109 opposite hinge axis 2110. As illustrated in FIG. 3B, arcuate member 2109 may define a displacement of appliance body 2102 away from a plane tangent to the surface of bendable flap 2108. As illustrated in the cross-sectional view of FIG. 3C, a thickness of arcuate member 2109 and hinge axis 2110 may be substantially less than a thickness of other portions of appliance body 2102, including bendable flap 2108 and shell 2104. In some examples, arcuate member 2109 may act as a spring and store potential energy in addition to the energy stored at the hinge axis 2110. By combining the combining the Modulus of Elasticity of bendable flap 2108, hinge axis 2110, and/or arcuate member 2109, a composite modulus of elasticity may closely approximates a horizontal line at about 10N than any of bendable flap 2108, hinge axis 2110, and/or arcuate member 2109 could achieve independently. In some examples, bendable flap 2108, hinge axis 2110, and/or arcuate member 2109 may be simpler and easier to engineer and manufacture compared to, for example, a continuous spring bellows surrounding a U-shaped bendable flap. For example, it may be easier to model and compute the forces in bendable flap 2108, hinge axis 2110, and/or arcuate member 2109 compared to, for example, a continuous spring bellows surrounding a U-shaped bendable flap. Such simplified modeling may reduce computational intensity or time when determining positions, dimensions, and shapes of bendable flaps and arcuate member to provide selected forces to teeth to achieve a selected treatment plan. Additionally, or alternatively, bendable flap 2108, hinge axis 2110, and/or arcuate member 2109 may be simpler to machine because only linear cut paths may be needed. In some examples, bendable flap 2108, hinge axis 2110, and/or arcuate member 2109 may be mass produced as premanufactured parts and attached later to a formed appliance body 2102. In such example, bendable flap 2108, hinge axis 2110, and/or arcuate member 2109 may be formed using continuous linear extrusion of material and cutting bendable flap 2108, hinge axis 2110, and/or arcuate member 2109 into individual parts of any given width. In some examples, at least a portion of appliance body 2102 adjacent bendable flap 2108 may define voids (e.g., slots 2013 may be enlarged). In some examples, by not transferring force directly to appliance body 2108 adjacent bendable flap 2108 deformation of appliance body 2108 may be reduced when such a concern is realized or in example where the close proximity of neighboring structures might be such that appliance body 2108 fit to the teeth may be compromised due to such deformation.

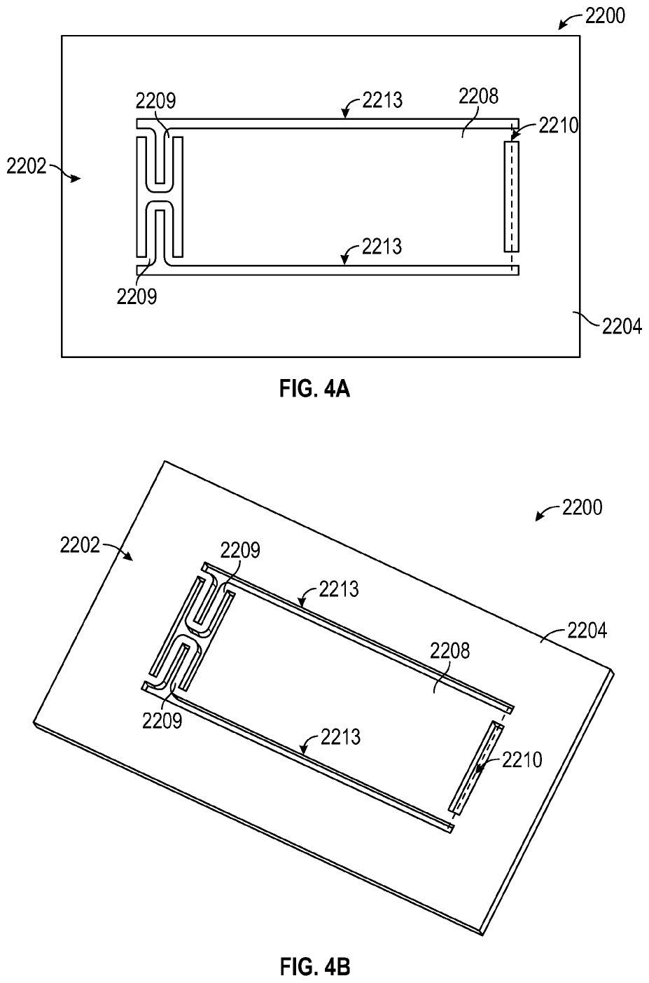

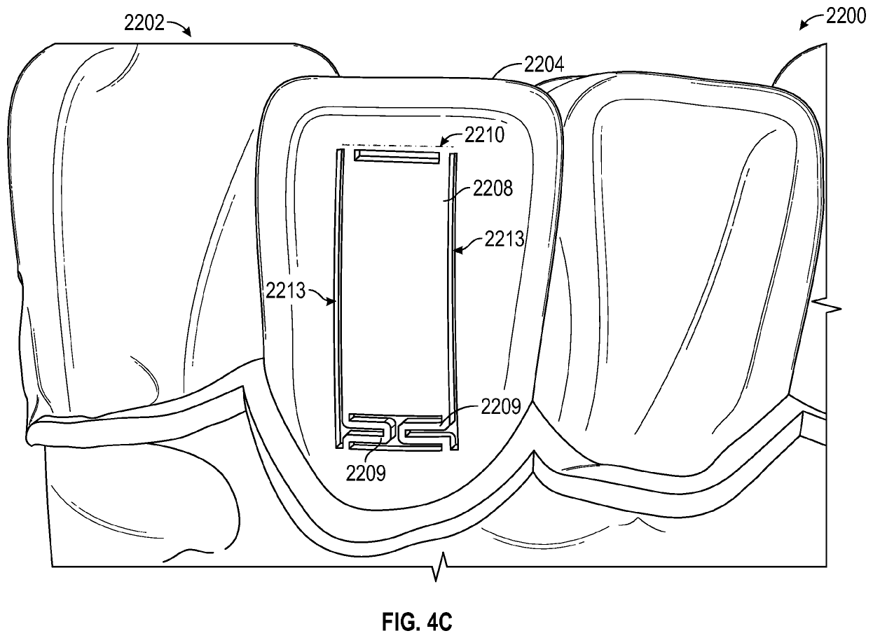

In some examples, an appliance body may include a bendable flap extending from a hinge axis including slots and defining slotted edges, and arcuate member opposite the hinge axis that includes zigzag springs in a plane tangential to a surface of the appliance body. FIGS. 4A-4C are conceptual diagrams illustrating an example removable dental appliance 2200 that includes a bendable flap 2208 extending from a slotted hinge axis 2210 and jumpers 2209 in a plane tangential to a surface of appliance body 2202 opposite hinge axis 2210. Removable dental appliance 2200 may be the same as or substantially similar to removable dental appliances 100 discussed above in reference to FIGS. 1A-1E, except for the differences describe herein.

As illustrated in FIGS. 4A-4C, bendable flap 2208 extends from appliance body 2202 at slotted hinge axis 2210. As discussed above, slotted hinge axis 2210 may have an increased flexibility compared to a hinge axis that is not slotted. Bendable flap 2208 defines slotted sides 2213. Slotted sides 2213 may include apertures extending through appliance body 2202. In other examples, slotted sides 2213 may include any suitable type of area of reduced shear resistance compared to adjacent portions of appliance body 2202. Appliance body 2202 includes arcuate members 2209 opposite hinge axis 2210. Arcuate members 2209 include zigzag shaped springs in a plane tangential to a surface of appliance body 2202. In some examples, arcuate members 2209 may enable bendable flap 2208 to move in a direction perpendicular to slotted hinge axis 2210 and in a lingual-labial direction. The movement of bendable flap 2208 may, in some examples, improve expression during movement of a respective tooth. In some examples, the configuration illustrated in FIGS. 4A-4C may be effective at isolating the shell 2204 from reaction forces. In some examples, bendable flap 2208, hinge axis 2210, and/or arcuate members 2209 may be simpler to machine because an end mill or laser cutter may be used to cut the features into appliance body 2202 after thermoforming appliance body 2202. As such, the configuration illustrated in FIGS. 4A-4C may be suited to design constraints and methods of manufacture that call for an appliance of substantially constant thickness. In some examples, by removing material along hinge axis 2210, deformation of bendable flap 2208 may be reduced to increase contact area with a tooth or allow for more predictable contact points. In some examples, the configuration illustrated in FIGS. 4A-4C may be more comfortable for the patient by protruding less into the direction of the tongue, lips, or cheeks. Many variations of the arcuate members 2209 are possible, such as, for example, one or more jumpers or variation in the amplitude, width, length, attachment points, or the like of the one or more jumpers.

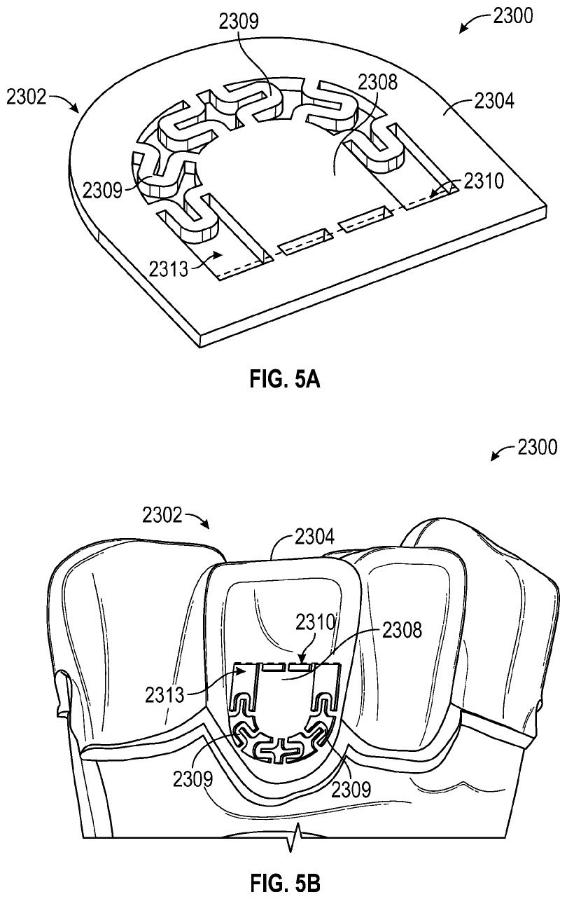

In some examples, an appliance body may include a bendable flap extending from a hinge axis including slots and a plurality of arcuate members bridging a flap boundary region. FIGS. 5A and 5B are conceptual diagrams illustrating an example removable dental appliance 2300 that includes a bendable flap 2308 extending from a slotted hinge axis 2310 and a plurality of jumpers 2309 bridging flap boundary region 2313 in a plane tangential to a surface of appliance body 2302 opposite hinge axis 2310. Removable dental appliance 2300 may be the same as or substantially similar to removable dental appliances 100 discussed above in reference to FIGS. 1A-1E, except for the differences describe herein.

As illustrated in FIGS. 5A and 5B, bendable flap 2308 extends from appliance body 2302 at slotted hinge axis 2310. Bendable flap 2308 defines flap boundary region 2213. Appliance body 2302 includes a plurality of arcuate members 2309 extending from shell 2304 to bendable flap 2308. Although six arcuate members 2309 are illustrated, in other examples, appliance body 2303 may include fewer or more arcuate members 2309. Arcuate members 2309 include zigzag shaped springs in a plane tangential to a surface of appliance body 2302. In some examples, arcuate members 2309 may enable bendable flap 2308 to move in the plane tangential to a surface of appliance body 2302 and in a lingual-labial direction. The movement of bendable flap 2208 may, in some examples, improve expression during movement of a respective tooth. Additionally, or alternately, the plurality of arcuate member 2309 may improve control of the direction or magnitude of a force applied by bendable flap 2308 to a surface of a tooth. The configuration illustrated in FIGS. 5A and 5B may enable increased force compared to other configuration by placing additional arcuate members 2309 along the sides of bendable flap 2308. In some examples, arcuate members 2309 may be omitted from the distal end of bendable flap 2308 (e.g., the end most distant from the hinge axis) to allow bendable flap 2308 to be positioned more closely to neighboring dental structures or force actuators. In some examples, the configuration illustrated in FIGS. 5A and 5B may allow for more flexible bendable flap 2308 by decreasing the number of arcuate members 2309 and increasing the length of arcuate members 2309. This is made possible by the increased length available when utilizing flap boundary region 2313 on the lateral sides of bendable flap 2308 in addition to the region at the distal end of bendable flap 2308.

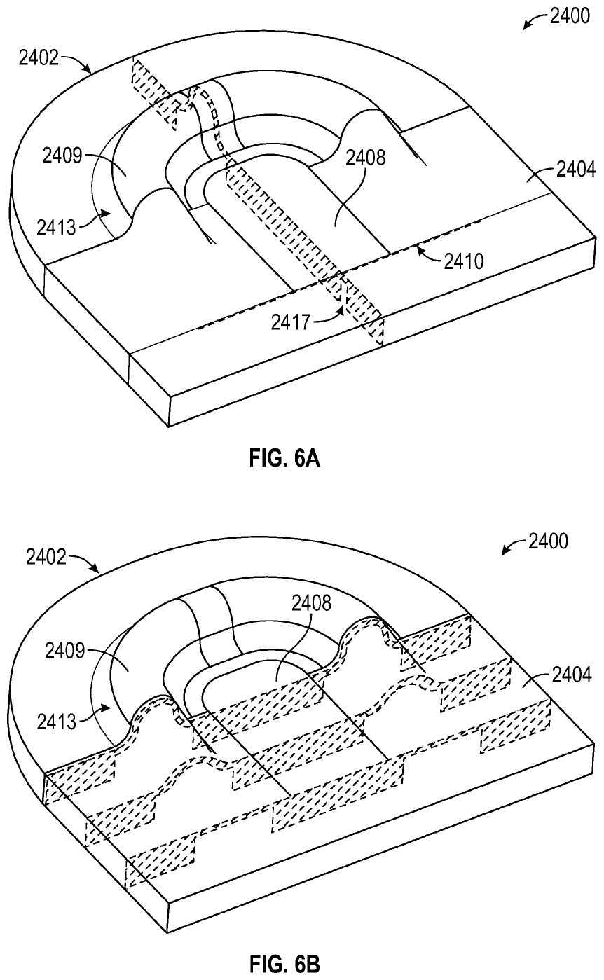

In some examples, an appliance body may include a bendable flap extending from a hinge axis and an arcuate member defining a spring bellows bridging at least a portion of a flap boundary region. FIGS. 6A and 6B are conceptual diagrams illustrating an example removable dental appliance 2400 that includes a bendable flap 2408 extending from a hinge axis 2410 and a spring bellows 2409 extending around an entire flap boundary region 2413. Removable dental appliance 2400 may be the same as or substantially similar to removable dental appliance 100 discussed above in reference to FIGS. 1A-1E, except for the differences describe herein.

As illustrated in FIGS. 6A and 6B, bendable flap 2408 extends from appliance body 2402 at hinge axis 2410. Hinge axis 2410 may include one or more voids 2417. Appliance body 2402 includes arcuate member 2409 extending around an entire flap boundary region 2413. As illustrated in FIGS. 6A and 6B, arcuate member 2409 may define a displacement of appliance body 2402 away from a plane tangential to the surface of shell 2404. As illustrated in the cross-sectional view of FIG. 6A, a thickness of arcuate member 2409 and hinge axis 2410 may be substantially less than a thickness of other portions of appliance body 2402, including bendable flap 2408 and shell 2404. The relatively thinner arcuate member 2409 and hinge axis 2410 may be more flexible than the surrounding appliance body 2402 or bendable flap 2408. Additionally, or alternatively, in some examples, one or more portions of arcuate member 2409 and hinge axis 2410 may include slots to reduce shear stress in selection regions. As illustrated in FIG. 6B, arcuate member 2409 may include a tapered spring bellows. The tapered spring bellows may be disposed in a plane tangential to a surface of appliance body 2402 near hinge axis 2410 and protrude further from the plane at other positions around flap boundary region 2413. In this way, portions of arcuate member 2409 nearer hinge axis 2410 may be less flexible than portions of arcuate member 2409 farther from hinge axis 2410. In some examples, arcuate member 2409 may include a plurality of undulations toward and away from the plane tangential to a surface of appliance body 2402. Such undulation may improve control of a direction and/or magnitude of force applied by arcuate member 2409 to bendable flap 2408. The configuration illustrated in FIGS. 6A and 6B may increase patient comfort by eliminating exposed edges of appliance material, provide substantially greater forces than other examples by increasing the effective length of the spring bellows to include the lateral sides of the flap, and/or reduce buildup of food and plaque, compared to appliance bodies having voids defining arcuate members. In some examples, appliance body 2402 may include fillets or chamfers to improve patient comfort and/or reduce buildup of food or plaque in corners or inside edges of appliance body 2402. In some examples, appliance body 2402 may be thermoformed without the need for post-processing, such as machining or cutting. In some examples, appliance body 2402 may be 3D printable without the need for support structures on or near bendable flap 2408, depending on appliance orientation in the printer (because of the elimination of exposed edges that might lack localized support).

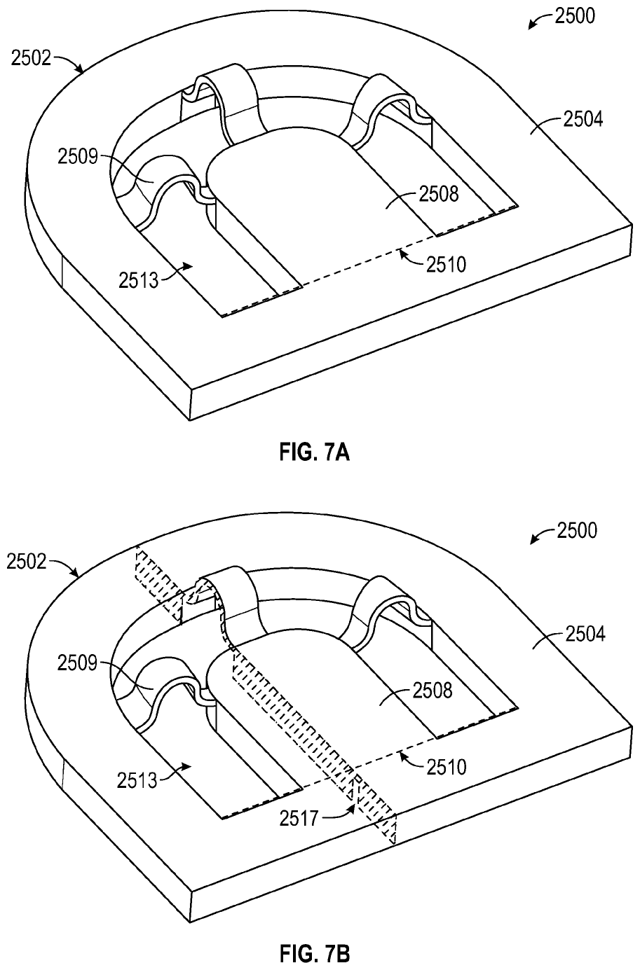

In some examples, an appliance body may include a bendable flap extending from a hinge axis and an arcuate members defining jumpers bridging at least a portion of a flap boundary region. FIGS. 7A and 7B are conceptual diagrams illustrating an example removable dental appliance 2500 that includes a bendable flap 2508 extending from a hinge axis 2510 and a plurality of jumpers 2509 bridging flap boundary region 2513. Removable dental appliance 2500 may be the same as or substantially similar to removable dental appliance 100 discussed above in reference to FIGS. 1A-1E, except for the differences describe herein.

As illustrated in FIGS. 7A and 7B, bendable flap 2508 extends from appliance body 2502 at hinge axis 2510. Hinge axis 2510 may include one or more voids 2517. Appliance body 2502 includes jumpers 2509 bridging flap boundary region 2513. As illustrated in FIGS. 7A and 7B, jumpers 2509 may define a displacement of appliance body 2502 away from a plane tangential to the surface of shell 2504. As illustrated in the cross-sectional view of FIG. 7B, a thickness of jumpers 2509 and hinge axis 2510 may be substantially less than a thickness of other portions of appliance body 2502, including bendable flap 2508 and shell 2504. The relatively thinner jumpers 2509 and hinge axis 2510 may be more flexible than the surrounding appliance body 2502 or bendable flap 2508. Additionally, or alternatively, in some examples, one or more portions of jumpers 2509 and hinge axis 2510 may include slots to reduce shear stress in selection regions. In some examples, the force may be lessened from by interrupting the continuity of jumpers 2509 with discrete through holes or shear reduction area, thus reducing the total area of jumpers 2509 without reducing thickness to the point of compromised durability, formability, printability, or the like. Jumpers 2509 can also be placed on the lateral sides only of bendable flap 2508 to reduce aspect ratio or length overall of bendable flap 2508. In some examples, the voids defined by appliance body 2502 (e.g., jumpers 2509) may increase salivary flow around the teeth and through the appliance, which can be beneficial toward the flushing out of acid which can, given prolonged contact with the teeth, lead to demineralization of tooth enamel, white spot lesions, dental caries, gingivitis, or the like.

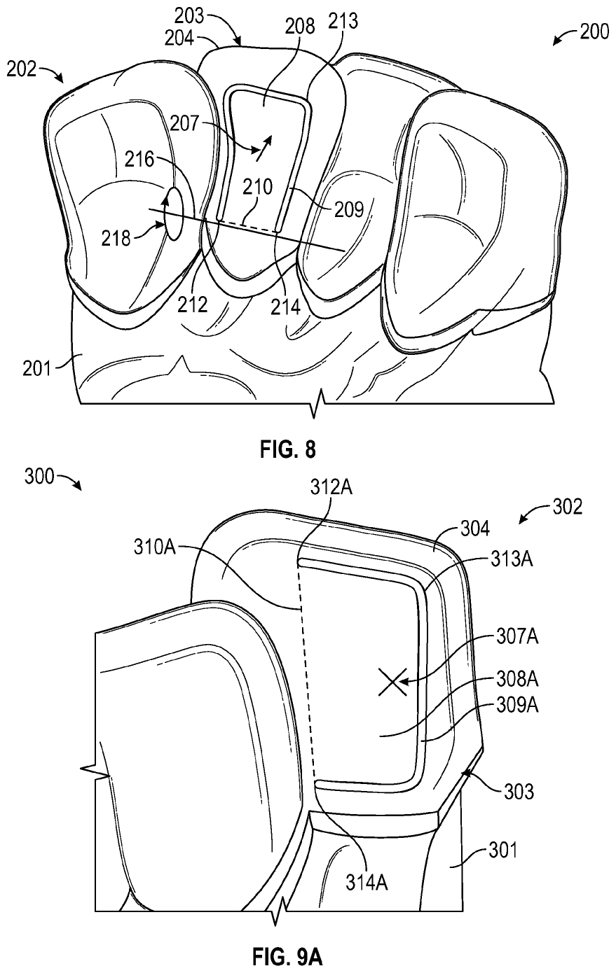

In general, a respective bendable flap and arcuate members may be integrally formed with a respective shell on any one of a lingual, facial, or occlusal surface of a respective appliance body. FIG. 8 illustrates a lingual view of a portion of an example removable dental appliance 200 that includes a plurality of shells, one of which is labeled in FIG. 8 as shell 204, a bendable flap 208 and an arcuate member 209 configured to apply a force 207 to a lingual surface of a tooth 203 of a patient. Removable dental appliance 200 may be the same as or substantially similar to removable dental appliance 100, 2000, 2100, 2200, 2300, 2400, or 2500 described above in reference to FIGS. 1A-7B, except for the differences described herein. Like removable dental appliance 100, removable dental appliance 200 may include an appliance body 202 configured to at least partially surround a plurality of teeth of mandibular arch 201 of a patient. Appliance body 202 defines a shell 204 shaped to engage tooth 203 in an initial position of tooth 203 and also receive tooth 203 in a desired position. Bendable flap 208 is integrally formed with appliance body 202 to extend from a hinge axis 210 of shell 204. Appliance body 202 also includes arcuate member 209 bridging flap boundary region 213, which includes a first end 212 and a second end 214. Appliance body 202 may or may not include gingival regions, similar to appliance body 102.

In the example of FIG. 8, bendable flap 208 and arcuate member 209 are positioned on a lingual side of appliance body 202 and is configured to apply force 207 to a lingual surface of tooth 203. For example, a rest position of bendable flap 208 intrudes into a space defined by tooth 203 in a desired position of tooth 203. When removable dental appliance 200 is worn by the patient, an initial position of tooth 203 causes a deformation of bendable flap 208 and arcuate member 209. The deformation of bendable flap 208 results in force 207. Force 207 is transferred from bendable flap 208 to tooth 203 by one or more contact points of bendable flap 208 with tooth 203, e.g., a surface of bendable flap 208 or protrusions from bendable flap 208. In some examples, bendable flap 208 and arcuate member 209 are positioned and shaped to concentrate force 207 near the incisal edge of tooth 203. By concentrating force 207 near the incisal edge of tooth 203, bendable flap 208 and arcuate member 209 may result in a torqueing of tooth 203 about an axis of rotation 216 in direction of rotation 218. Although not shown in FIG. 8, a surface of shell 204 may define a void internal to shell 204. As tooth 203 is torqued about axis of rotation 216, tooth 203 moves into the void and the facial surface of tooth 203 may contact the surface of shell 204.

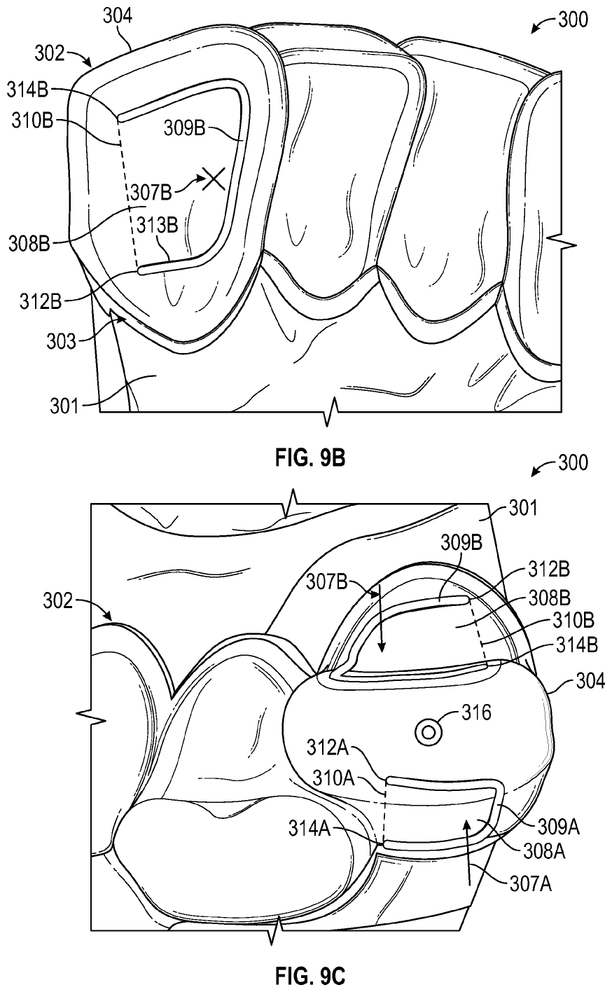

In some examples, a plurality of bendable flaps and a plurality of arcuate members may be on opposing sides of an appliance body. FIGS. 9A-9C illustrate labial, lingual, and occlusal views of an example removable dental appliance 300 that includes a plurality of shells, one of which is labeled in FIGS. 9A-9C as shell 304, bendable flaps 308A and 308B (collectively, “bendable flaps 308”) and arcuate members 309A and 309B (collectively, “arcuate members 309”) configured to apply respective forces 307A and 307B (collectively, “forces 307”) to tooth 303 of a patient. Removable dental appliance 300 may be the same as or substantially similar to removable dental appliances 100, 200, 2000, 2100, 2200, 2300, 2400, or 2500 described above in reference to FIGS. 1A-8, except for the differences described herein. For example, like removable dental appliance 100, removable dental appliance 300 may include appliance body 302 configured to at least partially surround a plurality of teeth, one of which is labeled in FIGS. 9A-9C as tooth 303, of the mandibular arch 301 of a patient. Appliance body 302 may or may not include gingival regions, similar to appliance body 102. Shell 304 may be shaped to engage tooth 303 in an initial position of tooth 303 and receive tooth 303 in a desired position of tooth 303. Appliance body 302 may define flap boundary region 313A having first end 312A and second end 314A. Bendable flap 308A may be integrally formed with appliance body 302 to extend from hinge axis 310A of shell 304.

In contrast to removable dental appliances 100 and 200, removable dental appliance 300 additionally includes second bendable flap 308B and second arcuate member 309B. Like bendable flap 308A, bendable flap 308B may be integrally formed with appliance body 302 to extend from hinge axis 310B of shell 304, where appliance body 302 defines flap boundary region 313B having first end 312B and second end 314B. As seen in FIG. 9C, bendable flap 308A is positioned on the facial side of removable dental appliance 300, whereas bendable flap 308B is positioned on the lingual side of removable dental appliance 300. Bendable flap 308A and arcuate member 309A may be configured to apply force 307A to a facial surface of tooth 303. Bendable flap 308B and arcuate member 309B may be configured to apply force 307B to a lingual surface of tooth 303. As seen in FIGS. 3A and 3B, forces 307A and 307B may be centered at about the same height of tooth 303 relative to a horizontal plane. In other examples, forces 307A and 307B may be centered at different heights of tooth 303.

Bendable flaps 308A and 308B may be positioned to form a couple. For example, force 307A may be substantially opposed to, and separated by a distance from, force 307B. The couple of forces 307A and 307B may result in a rotation of tooth 303 about an axis 316 approximately centered in tooth 303 and extending in the occlusal-gingival direction. Although not shown in FIGS. 9A-9C, a surface of shell 304 may define a void internal to shell 304 and shaped to receive tooth 303 in a desired position of tooth 303. For example, bendable flap 308A may be configured to apply force 307A to a facial-distal surface of tooth 303 opposite from the void to cause movement of tooth 303 toward the void. Similarly, the surface of shell 304 may define a second void internal to shell 304 and shaped to receive tooth 303 in a desired position of tooth 303. For example, bendable flap 308B may be configured to apply force 307B to a lingual-mesial surface of tooth 303 opposite from the second void to cause movement of tooth 303 toward the second void. In this way, bendable flaps 308 and shell 304 may be integrally formed to cause a movement of tooth 303 toward a desired position of tooth 303.

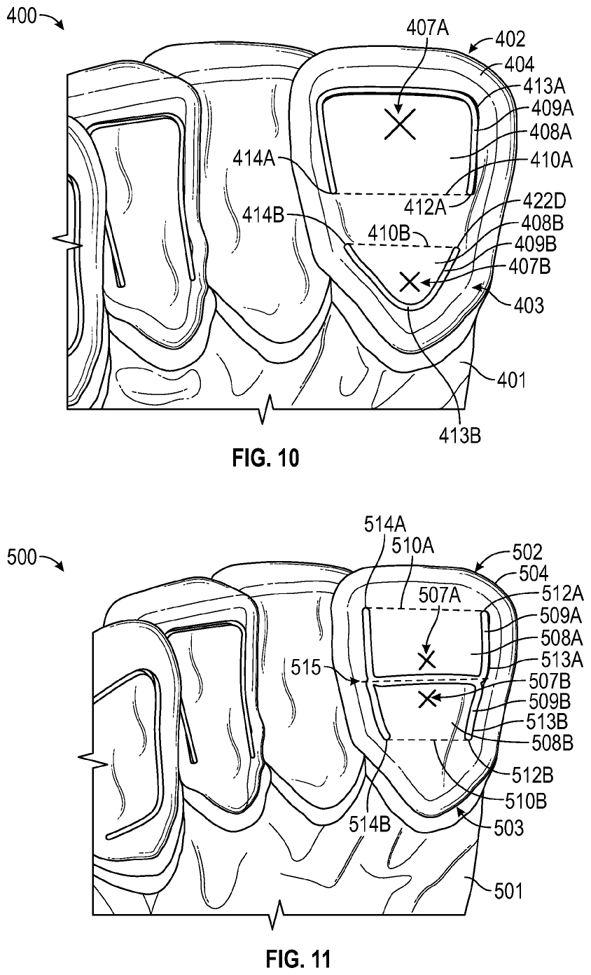

In some examples, a plurality of bendable flaps and a plurality of arcuate members may be on the same side of an appliance body. FIG. 10 illustrates a lingual view of an example removable dental appliance 400 that includes a plurality of shells, one of which is labeled in FIG. 10 as shell 404, a plurality of bendable flaps 408A and 408B (collectively, “bendable flaps 408”), and a plurality of arcuate members 409A and 409B (collectively, “arcuate members 409”) configured to apply respective forces 407A and 407B (collectively, “forces 407”) to tooth 403 of a patient. Removable dental appliance 400 may be the same as or substantially similar to removable dental appliances 100, 200, 300, 2000, 2100, 2200, 2300, 2400, or 2500 described above in reference to FIGS. 1A-9, except for the differences described herein. For example, like removable dental appliance 100, removable dental appliance 400 may include appliance body 402 configured to at least partially surround plurality of teeth, one of which is labeled in FIG. 10 as tooth 403, of the mandibular arch 401 of a patient. Appliance body 402 may or may not include gingival regions, similar to appliance body 102. Shell 404 may be shaped to engage tooth 403 in an initial position of tooth 403 and receive tooth 403 in a desired position of tooth 403. Appliance body 402 may include bendable flap 408A extending from hinge axis 410A of shell 404 and arcuate member 409A extending around flap boundary region 413A from first end 412A to second end 414A. Additionally, like removable dental appliance 300, removable dental appliance 400 may include second bendable flap 408B extending from second hinge axis 410B and second arcuate member 409B extending around flap boundary region 413B from first end 412B to second end 414B.

As illustrated in FIG. 10, bendable flaps 408A and 408B are positioned on the lingual side of removable dental appliance 400. Bendable flap 408A and arcuate member 409A may be configured to apply force 407A to a lingual surface near the incisal edge of tooth 403. Whereas bendable flap 408B and arcuate member 409B may be configured to apply force 407B to a lingual surface near the gingival margin of tooth 403. Forces 407A and 407B may be concentrated at about the center of tooth 403 (e.g., the center of an axis extending in the mesial-distal direction across tooth 403). In other examples, forces 407A and 407B may be concentrated at different locations on tooth 403.

Forces 407A and 407B may have similar or dissimilar magnitudes. In examples in which the magnitude of forces 407A and 407B are similar, tooth 403 may be translated in the facial direction. In examples in which the magnitude of forces 407A and 407B are dissimilar, tooth 403 may be both translated in the facial direction and tipped. For example, if force 407A has a greater magnitude than force 407B, tooth 403 may translate in the facial direction with an occlusal tipping in the facial direction. In some examples, dissimilar forces 407A and 407B may be used to reduce the moment of the resulting force on tooth 403, e.g., by considering the center of resistance of tooth 403. In this way, bendable flaps 408A and 408B may be configured to result in linear translation of tooth 403.

In some examples, a plurality of bendable flaps and a plurality of arcuate members on the same side of an appliance body may be configured to concentrate a respective plurality of forces. For example, FIG. 11 illustrates a lingual view of an example removable dental appliance 500 that includes a plurality of shells, one of which is labeled in FIG. 11 as shell 504, and a plurality of bendable flaps 508A and 508B and respective arcuate members 509A and 509B configured to apply respective forces 507A and 507B to tooth 503 of a patient.

Removable dental appliance 500 may be the same as or substantially similar to removable dental appliances 100, 200, 300, 400, 2000, 2100, 2200, 2300, 2400, or 2500 described above in reference to FIGS. 1A-10, except for the differences described herein. For example, like removable dental appliance 100, removable dental appliance 500 may include appliance body 502 configured to at least partially surround a plurality of teeth, including tooth 503, of the mandibular arch 501 of a patient. Appliance body 502 may or may not include gingival regions. Shell 504 may be shaped to engage tooth 503 in an initial position of tooth 503 and receive tooth 503 in a desired position of tooth 503. Appliance body 502 may define flap boundary region 513A having first end 512A and second end 514A. Bendable flap 508A may be integrally formed with appliance body 502 to extend from hinge axis 510A of shell 504. Additionally, like removable dental appliance 400, removable dental appliance 500 may include second bendable flap 508B integrally formed with appliance body 502 to extend from hinge axis 510B of shell 504, where appliance body 502 defines flap boundary region 513B having first end 512B and second end 514B. Bendable flaps 508A and 508B may be positioned on the lingual side of removable dental appliance 500.

As seen in FIG. 11, bendable flaps 508A and 508B and arcuate members 509A and 509B may be configured to apply forces 507A and 507B, respectively, to a lingual surface near the center of tooth 503. Forces 507A and 507B may be concentrated near the center of tooth 503 (e.g., center of a mesial-distal axis). In other examples, forces 507A and 507B may be concentrated at different locations on tooth 503 along a mesial-distal axis. In some examples, arcuate members 509A and 509B may be connected along a common axis 515. In other examples, at least one of arcuate members 509A and 509B may be coupled to both bendable flaps 508A and 508B along axis 515. By concentrating both forces 507A and 507B on the same portion of tooth 503, removable dental appliance 500 may transfer a greater magnitude of force to the portion of tooth 503 than may be possible with a single bendable flap. In this way, removable dental appliance 500 may achieve movement of tooth 503 in a shorter duration compared to a dental appliance without bendable flaps 508A and 508B.

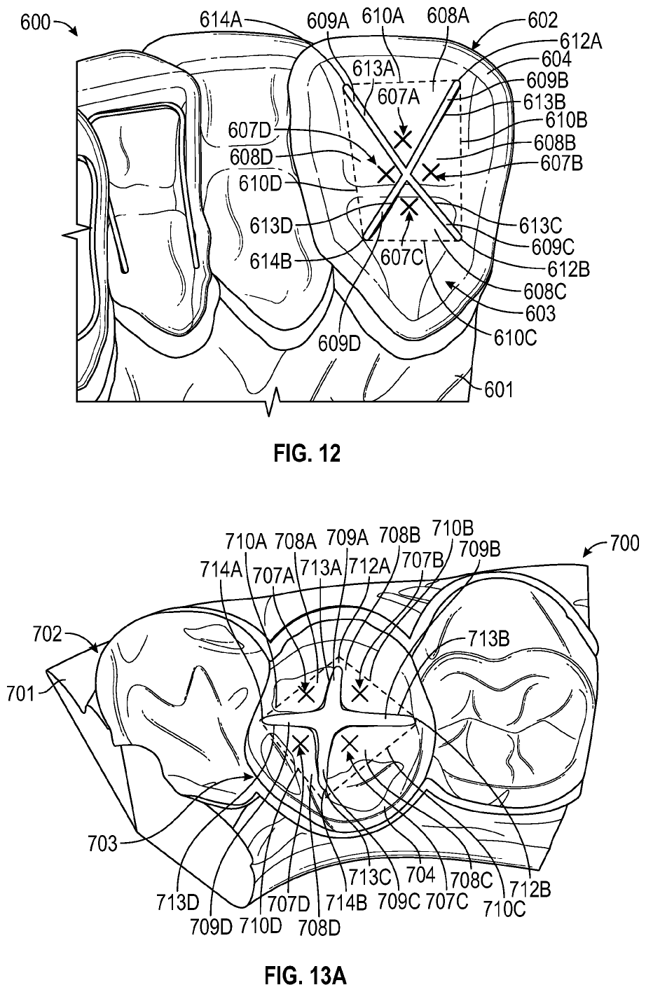

In some examples, a plurality of bendable flaps may include four or more bendable flaps and a corresponding plurality of arcuate members on the same side of an appliance body. The plurality of bendable flaps and plurality arcuate members may be configured to concentrate a respective plurality of forces in one or more locations on a respective tooth. For example, FIG. 12 illustrates a lingual view of an example removable dental appliance 600 that includes a plurality of shells, one of which is labeled in FIG. 12 as shell 604, a plurality of bendable flaps 608A, 608B, 608C, and 608D (collectively, “bendable flaps 608”) and a plurality of arcuate members 609A, 609B, 609C, and 609D (collectively, “arcuate members 609”) configured to apply forces 607A, 607B, 607C, and 607D to tooth 603 of a patient.

Removable dental appliance 600 may be the same as or substantially similar to removable dental appliances 100, 200, 300, 400, 500, 2000, 2100, 2200, 2300, 2400, or 2500 described above in reference to FIGS. 1A-11, except for the differences described herein. For example, like removable dental appliance 100, removable dental appliance 600 may include appliance body 602 configured to at least partially surround a plurality of teeth, including tooth 603, of the mandibular arch 601 of a patient. Appliance body 602 may or may not include gingival regions. Shell 604 may be shaped to engage tooth 603 in an initial position of tooth 603 and receive tooth 603 in a desired position of tooth 603. Appliance body 602 may define flap boundary region 613A having first end 612A and second end 614A. Bendable flap 608A may be integrally formed with appliance body 602 to extend from hinge axis 610A of shell 604. Additionally, like removable dental appliance 500, removable dental appliance 600 may include second bendable flap 608B integrally formed with appliance body 602 to extend from hinge axis 610B of shell 604, where appliance body 602 defines flap boundary region 613B having first end 612B and having second end 612A in common with bendable flap 608A.

In contrast to removable dental appliance 500, removable dental appliance 600 may also include third bendable flap 608C, a third arcuate member 609C, fourth bendable flap 608D, and a fourth arcuate member 609D. Bendable flaps 608 may be positioned on the lingual side of removable dental appliance 600. As illustrated in FIG. 12, bendable flaps 608 and arcuate members 609 may be configured to apply forces 607A, 607B, 607C, and 607D (collectively, “force 607”) to a lingual surface near the center of tooth 603. Force 607 may be centered near the center of tooth 603 (e.g., a center of tooth 603 along a mesial-distal axis across 603). In other examples, force 607 may be concentrated at different locations on tooth 603. For example, respective bendable flaps 608 and arcuate members 609 may be configured to apply a respective force of forces 607 at any position on the respective bendable flap of bendable flaps 608. By concentrating forces 607 on the same portion of tooth 603, removable dental appliance 600 may transfer a greater magnitude of force to the portion of tooth 603 than may be possible with one or two bendable flaps.

By transferring a greater magnitude of force to tooth 603, bendable flaps 608 and arcuate members 609 may cause a movement of tooth 603 in a shorter duration of time compared to fewer bendable flaps. For example, bendable flaps 608 may cause a translation of tooth 603 in a facial direction in a reduced amount of time compared to other dental appliances without bendable flaps 608 and/or and arcuate members 609. In other examples, bendable flaps 608 and arcuate members 609 may be configured to produce other tooth movements, or combinations of tooth movements, such as, for example, at least one of rotation, translation, tipping, torqueing, extrusion, and intrusion. Alternatively, or additionally, the greater magnitude of force to tooth 603 may enable removable dental appliance 600 to cause a movement of tooth 603 that may not be possible with fewer bendable flaps, e.g., translation of a premolar. In this way, removable dental appliance 600 may achieve a movement of tooth 603 that requires a relatively higher magnitude of force applied to tooth 603, a movement of tooth 603 in a shorter duration, or both compared to a dental appliance without bendable flaps 608.

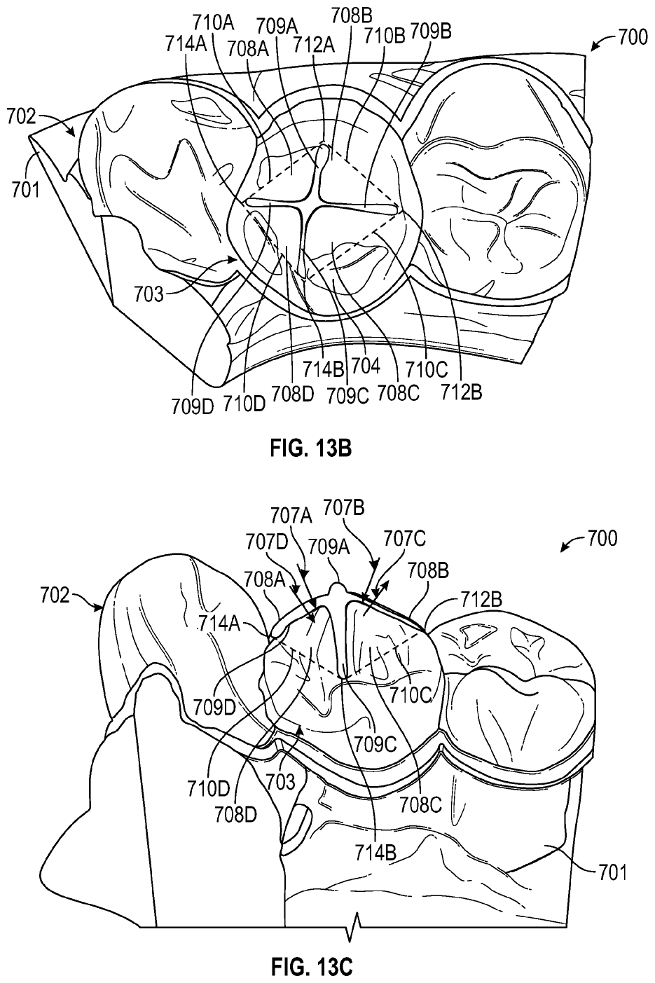

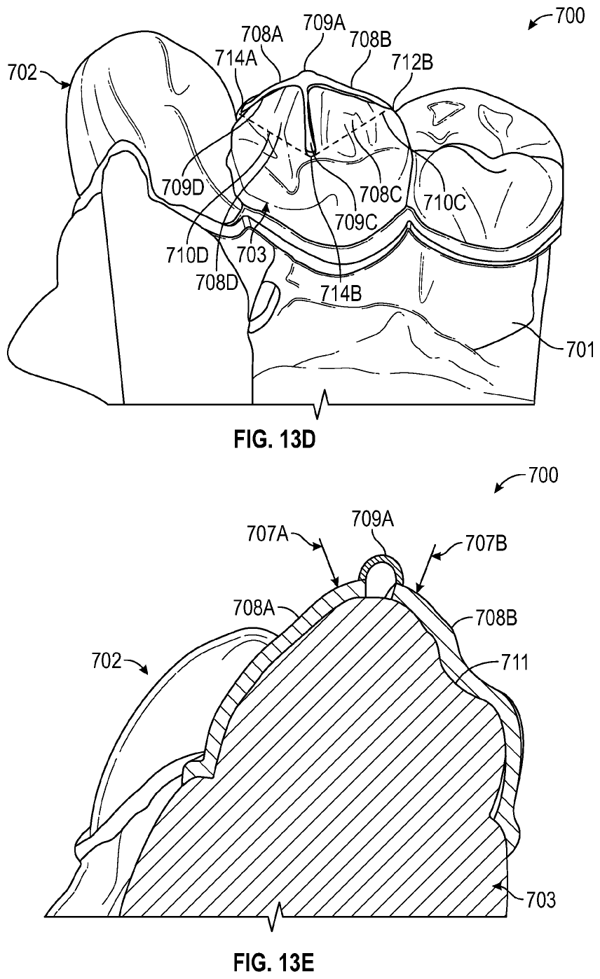

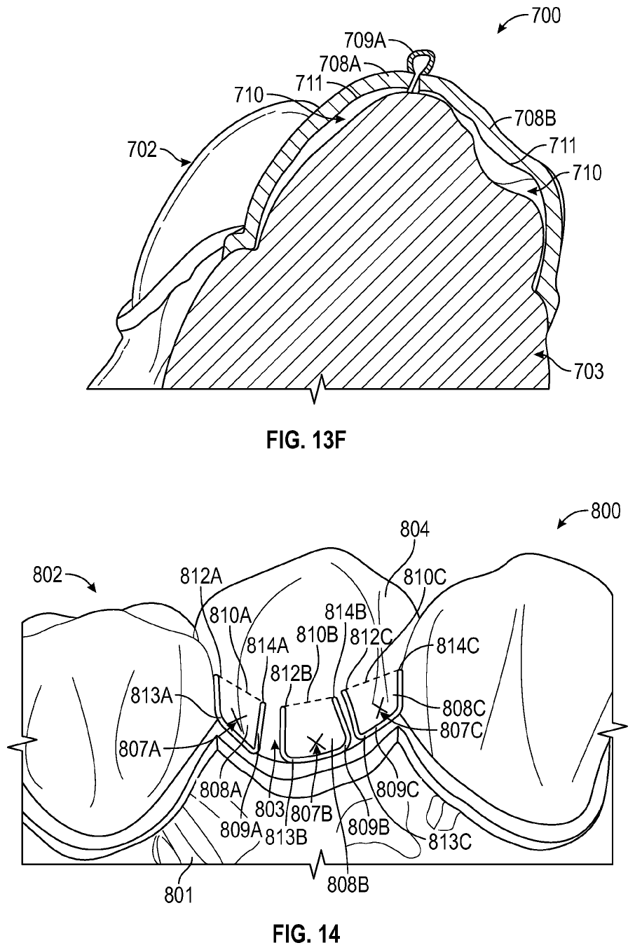

In some examples, one or more bendable flaps and arcuate members are configured to cause an intrusion of a respective tooth. For example, FIGS. 13A-13F illustrate occlusal, lingual, and distal cross-sectional views of an example removable dental appliance 700 that includes a plurality of shells, one of which is labeled in FIG. 7 as shell 704, a plurality of bendable flaps 708A, 708B, 708C, and 708D (collectively, “bendable flaps 708”) and a plurality of arcuate members 709A, 709B, 709C, and 709D (collectively, “arcuate members 709”) configured to apply respective forces 707A, 707B, 707C, and 707D (collectively, “forces 707”) to tooth 703 of a patent. FIG. 7A illustrates an occlusal view of a portion of removable dental appliance 700 surrounding tooth 703, in which tooth 703 is in an initial position, e.g., a maloccluded position. FIG. 7B illustrates an occlusal view of a portion of removable dental appliance 700 surrounding tooth 703, in which tooth 703 is in a desired position, e.g., a final position after orthodontic treatment or an intermediate position achieved by use of removable dental appliance 700. FIG. 7C illustrates a lingual view of removable dental appliance 700 surrounding tooth 703, in which tooth 703 is in an initial position. FIG. 7D illustrates a lingual view of a portion of removable dental appliance 700 surrounding tooth 703, in which tooth 703 is in a desired position. FIG. 7E illustrates a cross-sectional view of removable dental appliance 700 surrounding tooth 703 in an initial position. FIG. 7F illustrates a cross-sectional view of a portion of removable dental appliance 700 surrounding tooth 703 in a desired position.

Removable dental appliance 700 is the same as or substantially similar to removable dental appliances 100, 200, 300, 400, 500, 600, 2000, 2100, 2200, 2300, 2400, or 2500 described above in reference to FIGS. 1A-12, except for the differences described herein. For example, like removable dental appliance 100, removable dental appliance 700 includes appliance body 702 configured to at least partially surround a plurality of teeth, including tooth 703, of the mandibular arch 701 of a patient. Appliance body 702 may or may not include gingival regions, similar to appliance body 102. Shell 704 may be shaped to engage tooth 703 in an initial position of tooth 703 and receive tooth 703 in a desired position of tooth 703. Additionally, like removable dental appliance 600, the example of removable dental appliance 700 includes four bendable flaps 708 of arcuate members 709. For example, appliance body 702 defines flap boundary regions 713A, 713B, 713C, and 713D (collectively, “flap boundary regions 713”) having first end 712A, second end 714A, third intersection 712B, and fourth intersection 714B. Each respective bendable flap of bendable flap 708 is integrally formed with appliance body 702 to extend from a respective hinge axis 710A, 710B, 710C, and 710D (collectively, “hinge axes 710”) of shell 704.

As seen in FIGS. 13A-13F, bendable flaps 708 are positioned on or near an occlusal plane of removable dental appliance 700. Each respective bendable flap of bendable flaps 708 and respective arcuate members 709 are configured to apply a respective force of forces 707 to an occlusal surface of tooth 703. Forces 707 may be distributed substantially evenly across the occlusal surface of tooth 703 or concentrated in one or more portions of the occlusal surface of tooth 703. In examples in which forces 707 are evenly distributed, forces 707 may cause an intrusion of tooth 703. In other examples, forces 707 may be concentrated in one or more areas of tooth 703 to cause other movements in addition to intrusion, such as, tipping.

As shown in FIG. 7E, bendable flaps 708 are shaped to engage tooth 703 in an initial position of tooth 703. For example, when the removable dental appliance is worn by the patient, bendable flaps 708 and arcuate members 709 deform to an initial deformed position. Forces 707 are the greatest when bendable flaps 708 and arcuate members 709 are in the initial deformed position. In some examples, surface 711 of shell 704 corresponds to the shape of tooth 703 when bendable flaps 708 are in the deformed position. By corresponding to the shape of tooth 703 in the deformed position, bendable flaps 708 engage a greater portion of tooth 703. In this way, when the magnitude of force 707 is the greatest, control of the direction of forces 707 is the greatest. As tooth 703 moves in response to forces 707, bendable flaps 708 may become progressively less engaged with tooth 703 and forces 707 progressively diminish. For example, as illustrated in FIG. 7F, when tooth 703 reaches a desired position, void 710 is formed between surface 711 and tooth 703. Movement of tooth 703 continues until force 707 is insufficient to cause alveolar bone remodeling. For example, forces 707 may be insufficient to cause alveolar bone remodeling when bendable flaps 708 move to a position where one or more of flap boundary regions 709 converge to contact one another.

In other examples, surface 711 may correspond to the shape of tooth 703 in the desired position of tooth 703. For example, bendable flaps 708 may be in a state of lesser engagement with tooth 703 when tooth 703 is in an initial position. As tooth 703 moves in response to forces 707, the engagement of bendable flaps 708 may increase. In some examples, couples may be formed between tooth 703 and surface 711 such that tooth 703 moves in one or more translations or rotations as bendable flaps 708 progressively engage with tooth 703.

In some examples, one or more bendable flaps and one or more arcuate members are configured to cause an extrusion of a respective tooth. For example, FIG. 14 illustrates a buccal view of a portion of an example removable dental appliance 800 that includes a plurality of shells, one of which is labeled in FIG. 14 as shell 804, a plurality of bendable flaps 808A, 808B, and 808C (collectively, “bendable flaps 808”) and a plurality of arcuate members 809A, 809B, and 809C (collectively, “arcuate members 809”) configured to apply respective forces 807A, 807B, and 807C (collectively, “forces 807”) to tooth 803 of a patent.

Removable dental appliance 800 is the same as or substantially similar to removable dental appliances 100, 200, 300, 400, 500, 600, 700, 2000, 2100, 2200, 2300, 2400, or 2500 described above in reference to FIGS. 1A-13, except for the differences described herein. For example, like removable dental appliance 100, removable dental appliance 800 includes an appliance body 802 configured to at least partially surround a plurality of teeth, including tooth 803, of the mandibular arch 801 of a patient. Appliance body 802 may or may not include gingival regions. Shell 804 may be shaped to engage tooth 803 in an initial position of tooth 803 and receive tooth 803 in a desired position of tooth 803. Additionally, like removable dental appliance 400, the example of removable dental appliance 800 includes a plurality of bendable flaps 808 and a plurality of arcuate member 809. Appliance body 802 defines flap boundary region 813A having first end 812A and second end 814A, flap boundary region 813B having first end 812B and second end 814B, and flap boundary region 813C having first end 812C and second end 814C. Each respective bendable flap of bendable flaps 808 integrally formed with appliance body 802 to extend from a respective hinge axis 810A, 810B, and 810C (collectively, “hinge axes 810”) of shell 804.

As seen in FIG. 14, bendable flaps 808 are positioned near a gingival margin of tooth 803. Each respective bendable flap of bendable flaps 808 and arcuate members 809 are configured to apply a respective force of forces 807 to surface of tooth 803 below the height of contour of tooth 803. The height of contour of tooth 803 is the greatest amount of convexity or bulge of the crown. Bendable flaps 808 may be distributed substantially evenly across the facial and lingual portions of shell 804 such that forces 807 are distributed substantially evenly across both the lingual and facial sides of tooth 803. For example, although not shown in FIG. 14, a respective bendable flap positioned on a facial side of a respective shell may have a corresponding bendable flap positioned on a lingual side of the respective shell. In this way, forces 807 may be configured to extrude tooth 803, rather than merely translating or rotating tooth 803. In other examples, bendable flaps 808 and arcuate members 809 may be configured to cause other movements in addition to extrusion, such as, tipping, torqueing, translating, or rotating.

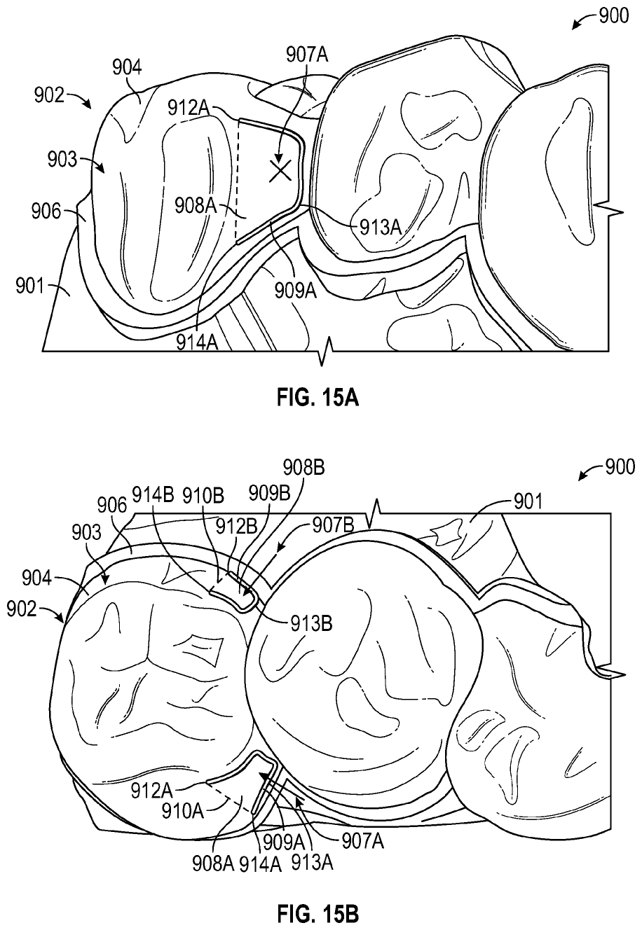

In some examples, one or more bendable flaps and arcuate members may be configured to cause a translation of a respective tooth. For example, FIGS. 15A and 15B illustrate buccal and occlusal views of an example removable dental appliance 900 that includes a plurality of shells, one of which is labeled in FIGS. 15A and 15B as shell 904, a plurality of arcuate members 909A and 909B (collectively, “arcuate members 909”) and a plurality of bendable flaps 908A and 908B (collectively, “bendable flaps 908”) configured to apply respective forces 907A and 907B (collectively, “forces 907”) to tooth 903 of a patient. FIG. 15A illustrates a buccal view of a portion of removable dental appliance 900 surrounding tooth 903, in which tooth 903 is in an initial position, e.g., a maloccluded position. FIG. 15B illustrates an occlusal view of a portion of removable dental appliance 900 surrounding tooth 903, in which tooth 903 is in an initial position.

Removable dental appliance 900 may be the same as or substantially similar to removable dental appliances 100, 200, 300, 400, 500, 600, 700, 800, 2000, 2100, 2200, 2300, 2400, or 2500 described above in reference to FIGS. 1A-14, except for the differences described herein. For example, like removable dental appliance 100, removable dental appliance 900 includes appliance body 902 configured to at least partially surround a plurality of teeth, including tooth 903, of the mandibular arch 901 of a patient. Appliance body 902 may or may not include gingival regions. Shell 904 may be shaped to engage tooth 903 in an initial position of tooth 903 and receive tooth 903 in a desired position of tooth 903. Additionally, like removable dental appliance 300, the example of removable dental appliance 900 includes two bendable flaps 908. For example, appliance body 902 defines flap boundary region 913A having first end 912A and second end 914A, and flap boundary region 913B having first end 912B and second end 914B. Each respective bendable flap of bendable flap 908 integrally formed with appliance body 902 extends from a respective hinge axis 910A and 910B (collectively, “hinge axes 910”) of shell 904B.

As seen in FIGS. 15A and 15B, bendable flaps 908 are positioned on opposing facial and lingual sides of removable dental appliance 900 near an interproximal region between shell 904 and the adjacent shell. Each respective bendable flap of bendable flaps 908 and arcuate members 909 are configured to apply a respective force of forces 907 to a surface of tooth 903 near the interproximal region of tooth 903 and the adjacent tooth. The magnitude of force 907A may be substantially similar to the magnitude of force 907B to cause a distal translation of tooth 903. In other examples, forces 907 may have dissimilar magnitudes or facially or lingually biased positions to cause a distal translation and a translation in either a facial or lingual direction, i.e., a translation along an angled axis relative to one of the ordinal tooth axes.

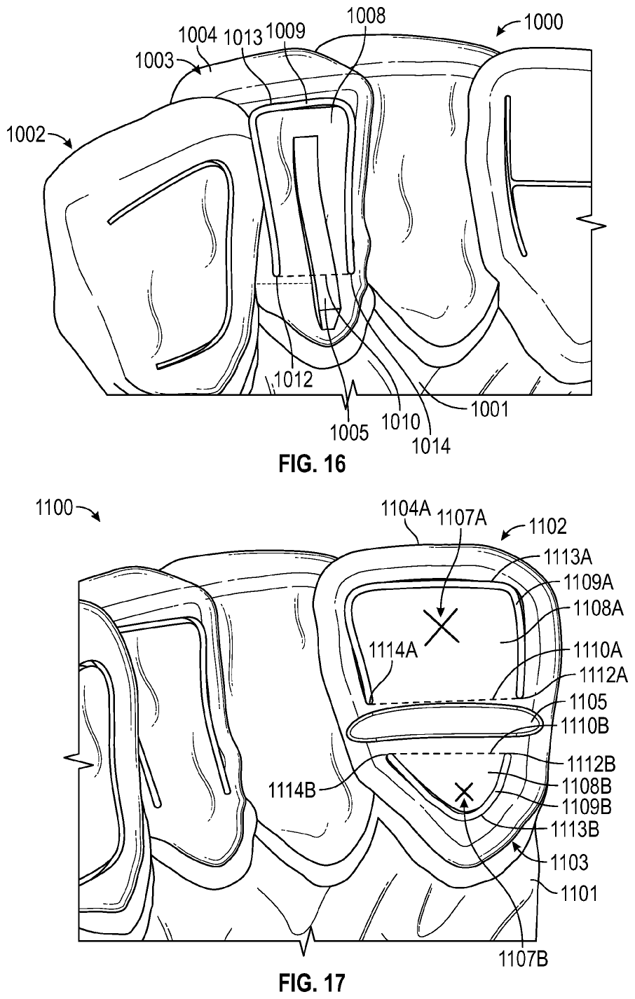

In some examples, at least one portion of an appliance body includes a reinforcing structure. The reinforcing structure may be configured to increase the stiffness of at least one bendable flap and/or arcuate member. As one example, FIG. 16 illustrates a lingual view of a portion of an example removable dental appliance 1000 that includes a plurality of shells, one of which is labeled in FIG. 16 as shell 1004, and at least one bendable flap 1008 configured to apply force 1007 to tooth 1003 of a patient.

Removable dental appliance 1000 may be the same as or substantially similar to removable dental appliances 100, 200, 300, 400, 500, 600, 700, 800, 900, 2000, 2100, 2200, 2300, 2400, or 2500 described above in reference to FIGS. 1A-15, except for the differences described herein. For example, like removable dental appliance 100, removable dental appliance 1000 includes an appliance body 1002 configured to at least partially surround a plurality of teeth, including tooth 1003, of the mandibular arch 1001 of a patient. Shell 1004 is shaped to engage tooth 1003 in an initial position of tooth 1003 and receive tooth 1003 in a desired position of tooth 1003. Additionally, like removable dental appliance 200, removable dental appliance 1000 includes bendable flap 1008 positioned on a lingual side of appliance body 1002. Appliance body 1002 defines flap boundary region 1009 having first end 1012 and second end 1014. Bendable flap 1008 is integrally formed with appliance body 1002 extends from a hinge axis 1010 of shell 1004. Appliance body 1002 may or may not include a gingival region.

As seen in FIG. 16, appliance body 1002 may include a reinforcing structure 1005. Reinforcing structure 1005 is positioned on bendable flap 1008. In other examples, the reinforcing structure may be positioned adjacent bendable flap 1008, such as on arcuate member 1009. Reinforcing structure 1005 is configured to increase the stiffness of at least a portion of appliance body 1002, such as bendable flap 1008 in FIG. 16. For example, reinforcing structure 1005 includes a strip of additional material to increase the stiffness of bendable flap 1008 when, as discussed above, bendable flap 1008 is deformed when removable dental appliance 1000 is worn by the patient. In some examples, reinforcing structure 1005 may include a jumper, as discussed above. In the example of FIG. 16, the additional material forming reinforcing structure 1005 is the same material as appliance body 1002. In other examples, the reinforcing structure may include at least one material having a higher elastic modulus than the appliance body material, such as, for example, a different polymer, a biocompatible metal, or the like. In some examples, one or more edges of reinforcing structure 1005 may be chamfered or filleted. Chamfering or filleting at least a portion of reinforcing structure 1005 may improve patient comfort. In this way, reinforcing structure 1005 may increase a stiffness of bendable flaps 1008 to increase a magnitude of the force provided by bendable flap 1008, improve control of the force provided by bendable flap 1008 and the resulting movement of tooth 1003, or both.

In some examples, rather than being on a bendable flap, a reinforcing structure may be positioned adjacent one or more bendable flaps. For example, FIG. 17 illustrates a lingual view of a portion of an example removable dental appliance 1100 that includes a plurality of shells, one of which is labeled in FIG. 17 as 1104, bendable flaps 1108A and 1108B and arcuate members 1109A and 1109B configured to apply respective forces 1107A and 1107B to tooth 1103 of a patient.

Removable dental appliance 1100 may be the same as or substantially similar to removable dental appliances 100, 200, 300, 400, 500, 600, 700, 800, 900, 1000, 2000, 2100, 2200, 2300, 2400, or 2500 described above in reference to FIGS. 1A-16, except for the differences described herein. For example, like removable dental appliance 100, removable dental appliance 1100 includes an appliance body 1102 configured to at least partially surround a plurality of teeth, such as tooth 1103, of the mandibular arch 1101 of a patient. Shell 1104 is shaped to engage tooth 1103 in an initial position of tooth 1103 and receive tooth 1103 in a desired position of tooth 1103. Additionally, like removable dental appliance 400, removable dental appliance 1100 includes bendable flaps 1108A and 1108B (collectively, “bendable flaps 1108”) positioned on a lingual side of appliance body 1102. Appliance body 1102 defines flap boundary region 1109A having first end 1112A and second end 1114A, and bendable flap boundary region 1109B having first end 1112B and second end 1114B. Bendable flaps 1108 are integrally formed with appliance body 1102 to extend from respective hinge axes 1110A and 1110B of shell 1104. Appliance body 1102 may or may not include gingival regions, similar to appliance body 102. Also, like removable dental appliance 1000, appliance body 1102 includes a reinforcing structure 1105.

Reinforcing structure 1105 is positioned adjacent bendable flaps 1108. Reinforcing structure 1105 is configured to increase the stiffness of at least a portion of appliance body 1102. For example, reinforcing structure 1105 includes a thickened region of shell 1104 or a strip of additional material on shell 1104 to increase the stiffness of a region of appliance body 1102 between first and second hinge axes 1110A and 1110B. When removable dental appliance 1100 is worn by the patient, bendable flaps 1108 deform. The deformation of bendable flaps 1108 may cause a deformation or stress in the region of appliance body 1102 between first and second hinge axes 1110A and 1110B. The additional material forming reinforcing structure 1105 may reduce the flexibility of the region of appliance body 1102 between first and second hinge axes 1110A and 1110B to resist this deformation and reduce the stress in the region of appliance body 1102 between first and second hinge axes 1110A and 1110B. In this way, reinforcing structure 1105 may improve concentration of deformation in bendable flaps 1108 to improve control of forces 1107 and the resulting movement of tooth 1103. Additionally, or alternatively, the additional material forming reinforcing structure 1105 may improve the durability of at least a portion of appliance body 1102. In this way, reinforcing structure 1105 may reduce the likelihood of permanent deformation or breakage of the at least a portion of appliance body 1102 when removable dental appliance 1100 is worn by the patient or fitted to the teeth.

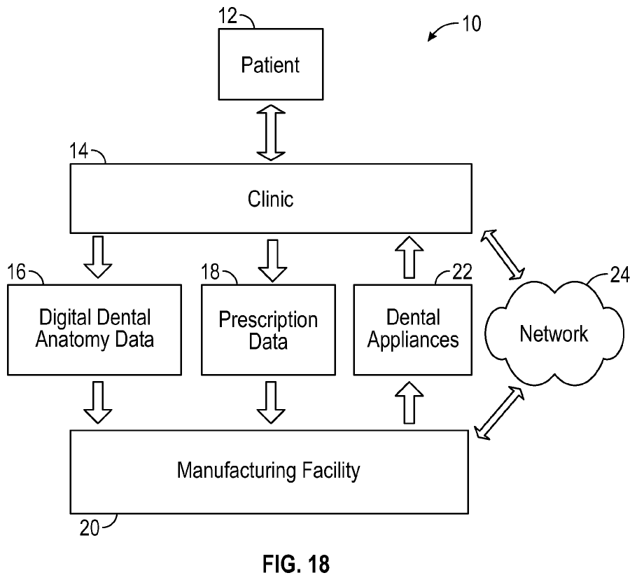

FIG. 18 is a block diagram illustrating an example computer environment 10 in which clinic 14 and manufacturing facility 20 communicate information throughout a manufacturing process of a set of removable dental appliances 22 for patient 12. The set of removable dental appliances 22 may include at least one of removable dental appliances 100, 200, 300, 400, 500, 600, 700, 800, 900, 1000, 1100, 2000, 2100, 2200, 2300, 2400, or 2500. As discussed above, removable dental appliances 100, 200, 300, 400, 500, 600, 700, 800, 900, 1000, 1100, 2000, 2100, 2200, 2300, 2400, or 2500 include a plurality of shells, at least one bendable flap, and at least one arcuate member. Initially, an orthodontic practitioner of clinic 14 generates one or more images of a dental anatomy of patient 12 using any suitable imaging technique and generates digital dental anatomy data 16 (e.g., a digital representation of patient's 12 tooth structure). For example, the practitioner may generate X-ray images that can be digitally scanned. Alternatively, the practitioner may capture digital images of the patient tooth structure using, for example, conventional computed tomography (CT), laser scanning, intra-oral scanning, CT scans of dental impressions, scans of dental casts poured from impressions, ultrasound instrumentation, magnetic resonance imaging (MRI), or any other suitable method of three-dimensional (3D) data acquisition. In other embodiments, the digital images may be provided using a hand-held intra-oral scanner such as the intra-oral scanner using active wavefront sampling developed by Brontes Technologies, Inc. (Lexington, Mass.) and described in PCT Publication No. WO 2007/084727 (Boerjes, et al.), which is incorporated herein by reference in its entirety. Alternatively, other intra-oral scanners or intra-oral contact probes may be used. As another option, the digital dental anatomy data 16 may be provided by scanning a negative impression of patient's 12 teeth. As still another option, the digital dental anatomy data 16 may be provided by imaging a positive physical model of patient's 12 teeth or by using a contact probe on a model of patient's 12 teeth. The model used for scanning may be made, for example, by casting an impression of patient's 12 dentition from a suitable impression material such as alginate or polyvinylsiloxane (PVS), pouring a casting material (such as orthodontic stone or epoxy resin) into the impression, and allowing the casting material to cure. Any suitable scanning technique may be used for scanning the model, including those described above. Other possible scanning methods are described in U.S. Patent Publication No. 2007/0031791 (Cinader et al.), which is incorporated herein by reference in its entirety.

In addition to providing digital images by scanning the exposed surfaces of the teeth, it is possible to image non-visible features of the dentition, such as the roots of patient's 12 teeth and patient's 12 jaw bones. In some embodiments, the digital dental anatomy data 16 is formed by providing several 3D images of these features and subsequently “stitching” them together. These different images need not be provided using the same imaging technique. For example, a digital image of teeth roots provided with a CT scan may be integrated with a digital image of the teeth crowns provided with an intraoral visible light scanner, for example, as describe in U.S. Patent Application No. 62/787,025, by Raby et al., which in incorporated herein by reference in its entirety. Scaling and registering of two-dimensional (2D) dental images with 3D dental images is described in U.S. Pat. No. 6,845,175 (Kopelman, et al.), which is incorporated herein by reference in its entirety, and U.S. Patent Publication No. 2004/0029068 (Badura, et al.), which is incorporated herein by reference in its entirety. Issued U.S. Pat. No. 7,027,642 (Imgrund, et al.), which is incorporated herein by reference in its entirety, and U.S. Pat. No. 7,234,937 (Sachdeva, et al.), which is incorporated herein by reference in its entirety, describe using techniques of integrating digital images provided from various 3D sources. Accordingly, the term “imaging” as it is used herein is not limited to normal photographic imaging of visually apparent structures, but includes imaging of dental anatomies that are hidden from view. The dental anatomy may include, but is not limited to, any portion of crowns or roots of one or more teeth of a dental arch, gingiva, periodontal ligaments, alveolar bone, cortical bone, implants, artificial crowns, bridges, veneers, dentures, orthodontic appliances, or any structure that could be considered part of the dentition before, during, or after treatment.

To generate digital dental anatomy data 16, a computer must transform raw data from the imaging systems into usable digital models. For example, for raw data representing the shapes of teeth received by a computer, the raw data is often little more than a point cloud in 3D space. Typically, this point cloud is surfaced to create 3D object models of the patient's dentition, including one or more teeth, gingival tissue, and other surrounding oral structure. For this data to be useful in orthodontic diagnosis and treatment, the computer may “segment” dentition surfaces to produce one or more discrete, movable 3D tooth object models representing individual teeth. The computer may further separate these tooth models from the gingiva into separate objects.

Segmentation allows a user to characterize and manipulate the teeth arrangement as a set of individual objects. Advantageously, the computer may derive diagnostic information such as arch length, bite setting, interstitial spacing between adjacent teeth, and even American Board of Orthodontics (ABO) objective grading from these models. As a further benefit, the digital orthodontic setups may provide flexibility in the manufacturing process. By replacing physical processes with digital processes, the data acquisition step and data manipulation steps can be executed at separate locations without the need to transport stone models or impressions from one location to another. Reducing or eliminating the need for shipping physical objects back and forth can result in significant cost savings to both customers and manufacturers of customized appliances.

After generating digital dental anatomy data 16, clinic 14 may store digital dental anatomy data 16 within a patient record in a database. Clinic 14 may, for example, update a local database having a plurality of patient records. Alternatively, clinic 14 may remotely update a central database (optionally within manufacturing facility 20) via network 24. After digital dental anatomy data 16 is stored, clinic 14 electronically communicates digital dental anatomy data 16 to manufacturing facility 20. Alternatively, manufacturing facility 20 may retrieve digital dental anatomy data 16 from the central database. Alternatively, manufacturing facility 20 may retrieve preexisting digital dental anatomy data 16 from a data source unassociated with clinic 14.

Clinic 14 may also forward prescription data 18 conveying general information regarding a practitioner's diagnosis and treatment plan for patient 12 to manufacturing facility 20. In some examples, prescription data 18 may be more specific. For example, digital dental anatomy data 16 may be a digital representation of the dental anatomy of patient 12. The practitioner of clinic 14 may review the digital representation and indicate at least one of desired movements, spacing, or final positions of individual teeth of patient 12. For example, the desired movements, spacing, and final positions of individual teeth of patient 12 may affect the forces to be applied to the teeth of patient 12 at each stage of treatment by each removable dental appliance of the set of removable dental appliances 22. As discussed above, the forces applied by each removable dental appliance (e.g., removable dental appliance 100, 200, 300, 400, 500, 600, 700, 800, 900, 1000, 1100, 2000, 2100, 2200, 2300, 2400, or 2500) of the set of removable dental appliances 22 may be determined by selecting the dimensions, shapes, and positions of at least one of the plurality of shells (e.g., shells 104, 204, 304, 404, 504, 604, 704, 804, 904, 1004, 1104, 2004, 2104, 2204, 2304, 2404, or 2504), at least one bendable flap (e.g., bendable flaps 108C, 208, 308A, 308B, 408A, 408B, 508A, 508B, 608A, 608B, 608C, 608D, 708A, 708B, 708C, 708D, 808A, 808B, 808C, 908A, 908B, 1008, 1008A, 1108B, 2008, 2108, 2208, 2408, or 2508), at least one arcuate member (e.g., arcuate members 109C, 209, 309A, 309B, 409A, 409B, 509A, 509B, 609A, 609B, 609C, 609D, 709A, 709B, 709C, 709D, 809A, 809B, 809C, 909A, 909B, 1009, 1009A, 1109B, 2009, 2109, 2209, 2409, or 2509), at least one reinforcing structures (e.g., reinforcing structures 1005 or 1105), and the like. The at least one of desired movements, spacing, or final positions of individual teeth of patient 12 may enable the practitioner, a technician at manufacturing facility 20, and a computer at manufacturing facility 20 to determine at least one of selected dimensions, shapes, and positions of at least one of the shells, bendable flaps, arcuate members, and reinforcing structures. In this way, digital dental anatomy data 16 may include at least one of practitioner, technician, or computer selected dimensions, shapes, and positions of at least one of shells, bendable flaps, arcuate members, and reinforcing structures of each of removable dental appliance of the set of removable dental appliances 22 to result in the desired movement of the teeth of patient 12. Following review of the digital representation, the digital dental anatomy data 16 that includes the selected dimensions, shapes, and positions of shells, bendable flaps, arcuate members, and reinforcing structures of each removable dental appliance of the set of removable dental appliances 22, may be forwarded to manufacturing facility 20. Manufacturing facility 20 may be located off-site, or located with clinic 14.

For example, each clinic 14 may include on-site equipment for manufacturing facility 20 such that a treatment plan and digital design may be performed entirely by a clinical practitioner, or an assistant, in the clinical setting, using software installed locally. The manufacturing may be performed in the clinic, as well, by using a 3D printer (or by other methods of additive manufacturing). A 3D printer allows manufacturing of intricate features of a dental appliance or a physical representation of the dental anatomy of patient 12 through additive printing. The 3D printer may use iterative digital designs of original dental anatomy of patient 12 as well as a desired dental anatomy of patient 12 to produce multiple digital appliances, digital appliance patterns customized to produce the desired dental anatomy of patient 12, or both. Manufacturing may include post-processing to remove uncured resin and remove support structures, or to assemble various components, which may also be necessary and could also be performed in a clinical setting.

Manufacturing facility 20 utilizes digital dental anatomy data 16 of patient 12 to construct the set of removable dental appliances 22 to reposition teeth of patient 12. Sometime thereafter, manufacturing facility 20 forwards the set of removable dental appliances 22 to clinic 14 or, alternatively, directly to patient 12. For example, the set of removable dental appliances 22 may be an ordered set of removable dental appliances. Patient 12 then wears the removable dental appliances 22 in the set of removable dental appliances 22 sequentially over time according to a prescribed schedule to reposition the teeth of patient 12. For example, patient 12 may wear each removable dental appliance in the set of removable dental appliances 22 for a period of between about 1 week and about 6 weeks, such as between about 2 weeks and about 4 weeks, or about 3 weeks. Optionally, patient 12 may return to clinic 14 for periodic monitoring of the progress of the treatment with removable dental appliances 22.

During such periodic monitoring, a clinician may adjust the prescribed schedule of patient 12 for wearing the removable dental appliances in the set of removable dental appliances 22 sequentially over time. Monitoring generally includes visual inspection of the teeth of patient 12 and may also include imaging to generate digital dental anatomy data. In some examples, the clinician may decide to interrupt the treatment of patient 12 with the set of removable dental appliances 22, for example, by sending the newly generated digital dental anatomy data 16 to manufacturing facility 20 in order to produce a new set of removable dental appliances 22. In some examples, the clinician may send newly generated digital dental anatomy data 16 to manufacturing facility 20 following the completion of the prescribed schedule of the treatment with removable dental appliances 22. In some examples, following the completion of the prescribed schedule of the treatment with removable dental appliances 22, the clinician may request a new set of removable dental appliances from manufacturing facility 20 to continue treatment of patient 12.

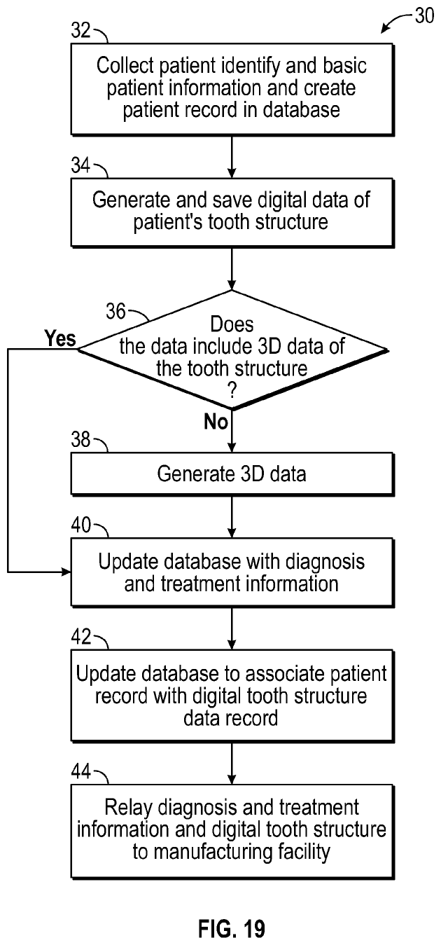

FIG. 19 is a flow diagram illustrating process 30 conducted at clinic 14 in accordance with one example of this disclosure. Initially, a practitioner at clinic 14 collects patient identity and other information from patient 12 and creates a patient record (32). As described above, the patient record may be located within clinic 14 and optionally configured to share data with a database within manufacturing facility 20. Alternatively, or additionally, the patient record may be located within a database at manufacturing facility 20 that is remotely accessible to clinic 14 via network 24 or within a database that is remotely accessible by both manufacturing facility 20 and clinic 14.

Next, digital dental anatomy data 16 of patient 12 may be generated using any suitable technique (34), to thereby create a virtual dental anatomy. Digital dental anatomy data 16 may be comprised of a two-dimensional (2D) image, a three-dimensional (3D) representation of the dental anatomy, or both.

In one example, 3D representations of a dental anatomy are generated using a cone beam computerized tomography (CBCT) scanner, such as an i-CAT 3D dental imaging device (available from Imaging Sciences International, LLC; 1910 N Penn Road, Hatfield, Pa.). Clinic 14 stores the 3D digital dental anatomy data 16 (in the form of radiological images) generated from the CBCT scanner in the database located within clinic 14, or alternatively, within manufacturing facility 20. The computing system processes the digital dental anatomy data 16 from the CBCT scanner, which may be in the form of a plurality of slices, to compute a digital representation of the tooth structure that may be manipulated within the 3D modeling environment.

If 2D radiological images are used (36), then the practitioner may further generate 3D digital data (38). The 3D digital dental anatomy data 16 may be produced by, for example, forming and subsequently digitally scanning a physical impression or casting of the tooth structure of patient 12. For example, a physical impression or casting of a dental arch of patient 12 may be scanned using a visible light scanner, such as an OM-3R scanner (available from Laser Design, Inc. of Minneapolis, Minn.) or an ATOS scanner (available from GOM GmbH of Braunschweig, Germany). Alternatively, the practitioner may generate the 3D digital dental anatomy data 16 of the occlusal service by use of an intra-oral scan of the dental arch of patient 12, or existing 3D tooth data. In one example, the method of forming a digital scan from a casting or an impression described in U.S. Pat. No. 8,491,306, by Raby et al., which is incorporated herein by reference in its entirety, may be used. In the same or different examples, techniques for defining a virtual tooth surface and virtual tooth coordinate system as described in U.S. Patent Application Publication No. 2013/0325431, by See et al., which is incorporated herein by reference in its entirety, may be used. In any case, the digital data are digitally registered within the 3D modeling environment to form a composite digital representation of a tooth structure, which may include the tooth roots as well as the occlusal surfaces.

In one example, 2D radiological images and the 3D digital data for the occlusal surface of the dental arch are registered by first attaching registration markers (e.g., fiducial markers or a pedestal having known geometry) to the tooth structure of patient 12 prior to generating both the radiological images and the 3D digital scan. Thereafter, the digital representation of the registration markers within the 2D radiological image and the 3D digital data may be aligned within a 3D modeling environment using registration techniques described in U.S. Pat. No. 8,491,306.

In another example, 3D digital data of the tooth structure is generated by combining two 3D digital representations of the tooth structure. For example, a first 3D digital representation may be a relatively low-resolution image of the roots obtained from a CBCT scanner (e.g., an i-CAT 3D dental imaging device) and the second 3D digital representation may be a relatively high-resolution image of the crowns of the teeth obtained from an industrial CT scan of an impression or a visible light (e.g., laser) scan of a casting of the dental arch of the patient. The 3D digital representations may be registered using a software program that enables the 3D representations to be manipulated within a computer environment (e.g., Geomagic Studio software (available from 3D Systems, Inc.; 333 Three D Systems Circle, Rock Hill, S.C.), or alternatively, registration techniques described in U.S. Pat. No. 8,491,306 may be used.

Next, a computer system executing 3D modeling software renders a resultant digital representation of the tooth structure, including the occlusal surface as well as the root structure of the patient's dental arch. Modeling software provides a user interface that allows the practitioner to manipulate digital representations of the teeth in 3D space relative to the digital representation of the patient's dental arch. By interacting with the computer system, the practitioner generates treatment information, such as by selecting indications of the desired positions, final positions, or both of individual teeth of patient 12, duration of a respective stage of treatment, or number of treatment stages, the direction or magnitude of forces on the teeth of patient 12 during a stage of treatment, or the like (40). In some examples, bendable flaps may be used during at least one, but fewer than all stages of treatment. For example, the desired positions of individual teeth of patient 12, duration of a respective stage of treatment, or number of treatment stages may affect the direction or magnitude of forces on the teeth of patient 12 at each stage of treatment by each removable dental appliance of the set of removable dental appliances 22. As discussed above, the forces applied by each removable dental appliance (e.g., removable dental appliances 100, 200, 300, 400, 500, 600, 700, 800, 900, 1000, 1100, 2000, 2100, 2200, 2300, 2400, or 2500) of the set of removable dental appliances 22 may be determined by selecting the dimensions, shapes, and positions of at least one of the plurality of shells (e.g., shells 104, 204, 304, 404, 504, 604, 704, 804, 904, 1004, 1104, 2004, 2104, 2204, 2304, 2404, or 2504), bendable flaps (e.g., bendable flaps 108C, 208, 308A, 308B, 408A, 408B, 508A, 508B, 608A, 608B, 608C, 608D, 708A, 708B, 708C, 708D, 808A, 808B, 808C, 908A, 908B, 1008, 1008A, 1108B, 2008, 2108, 2208, 2408, or 2508), at least one arcuate member (e.g., arcuate members 109C, 209, 309A, 309B, 409A, 409B, 509A, 509B, 609A, 609B, 609C, 609D, 709A, 709B, 709C, 709D, 809A, 809B, 809C, 909A, 909B, 1009, 1009A, 1109B, 2009, 2109, 2209, 2409, or 2509), reinforcing structures (e.g., reinforcing structures 1005 or 1105), and the like. In this way, updating the database with diagnostic and treatment information (40) may include determining or selecting by the practitioner, a technician, or automatically by a computer the dimensions, shapes, and positions of the plurality of shells, at least one bendable flap, at least one reinforcing structure, and the like of each of removable dental appliance of the set of removable dental appliances 22 to result in the desired movement of the teeth of patient 12.

Once the practitioner has finished conveying general information regarding a diagnosis and treatment plan within the 3D environment, the computer system updates the database associated with the patient record to record the prescription data 18 conveying general information regarding a diagnosis and treatment plan as specified by the practitioner (42). Thereafter, the prescription data 18 is relayed to manufacturing facility 20 for manufacturing facility 20 to construct one or more removable dental appliances including at least one bendable flap, such as removable dental appliances 22 (44).

Although described with respect to an orthodontic practitioner located at an orthodontic clinic, one or more of the steps discussed with respect to FIG. 19 may be performed by a remote user, such as a user located at manufacturing facility 20. For example, the orthodontic practitioner may only send radiological image data and an impression or casting of the patient to manufacturing facility 20, where a user interacts with a computer system to develop a treatment plan within a 3D modeling environment. Optionally, a digital representation of the treatment plan within the 3D modeling environment may then be transmitted to the orthodontic practitioner of clinic 14, who may review the treatment plan and either send back his or her approval, or indicate desired changes.

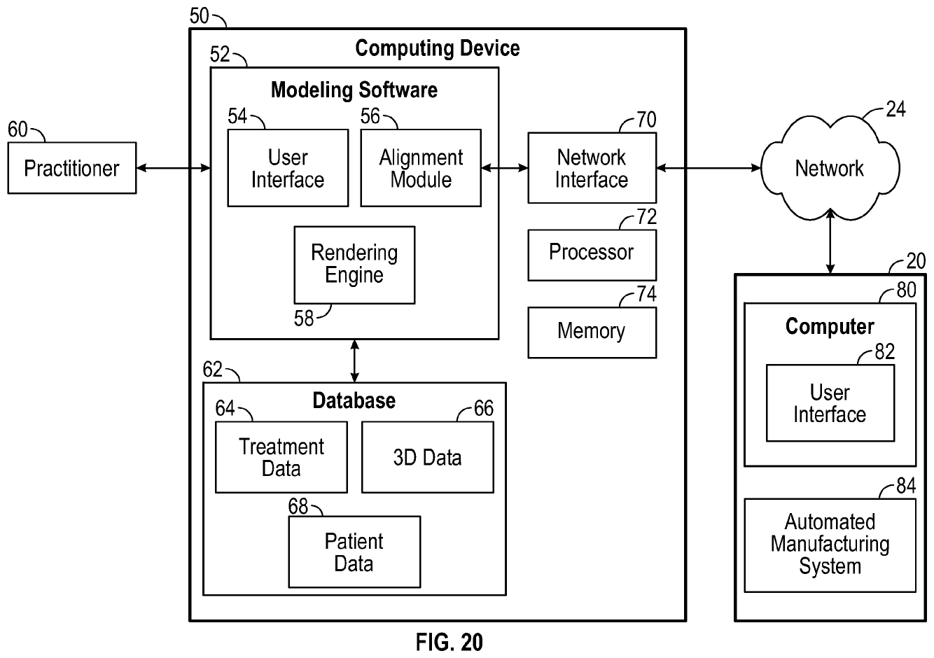

FIG. 20 is a block diagram illustrating an example of a client computer 50 connected to manufacturing facility 20 via network 24. In the illustrated example, client computer 50 provides an operating environment for modeling software 52. Modeling software 52 presents a modeling environment for modeling and depicting the 3D representation of the teeth of patient 12. In the illustrated example, modeling software 52 includes user interface 54, alignment module 56, and rendering engine 58.

User interface 54 provides a graphical user interface (GUI) that visually displays the 3D representation of patient's 12 teeth. In addition, user interface 54 provides an interface for receiving input from practitioner 60 of clinic 14, e.g., via a keyboard and a pointing device, a touchscreen, or the like, for manipulating patient's 12 teeth within the modeled dental arch.

Modeling software 52 may be accessible to manufacturing facility 20 via network interface 70. Modeling software 52 interacts with database 62 to access a variety of data, such as treatment data 64, 3D data 66 relating to the tooth structure of patient 12, and patient data 68. Database 62 may be represented in a variety of forms including data storage files, lookup tables, or a database management system (DBMS) executing on one or more database servers. The database management system may be a relational (RDBMS), hierarchical (HDBMS), multi-dimensional (MDBMS), object oriented (ODBMS or OODBMS) or object relational (ORDBMS) database management system. The data may, for example, be stored within a single relational database, such as SQL Server from Microsoft Corporation. Although illustrated as local to client computer 50, database 62 may be located remote from the client computer 50 and coupled to the client computer 50 via a public or private network, e.g., network 24.

Treatment data 64 describes diagnosis or repositioning information for the teeth of patient 12 selected by practitioner 60 and positioned within the 3D modeling environment. For example, treatment data 64 may include the dimensions, shapes, and positions of at least one of the plurality of shells (e.g., shells 104, 204, 304, 404, 504, 604, 704, 804, 904, 1004, 1104, 2004, 2104, 2204, 2304, 2404, or 2504), at least one bendable flap (e.g., bendable flaps 108C, 208, 308A, 308B, 408A, 408B, 508A, 508B, 608A, 608B, 608C, 608D, 708A, 708B, 708C, 708D, 808A, 808B, 808C, 908A, 908B, 1008, 1008A, 1108B, 2008, 2108, 2208, 2408, or 2508), at least one arcuate member (e.g., arcuate members 109C, 209, 309A, 309B, 409A, 409B, 509A, 509B, 609A, 609B, 609C, 609D, 709A, 709B, 709C, 709D, 809A, 809B, 809C, 909A, 909B, 1009, 1009A, 1109B, 2009, 2109, 2209, 2409, or 2509), at least one reinforcing structure (e.g., reinforcing structures 1005 or 1105), and the like that may result in a selected magnitude and direction of force vectors to be applied to teeth of a patient (e.g., teeth 103) throughout the treatment plans.

Patient data 68 describes a set of one or more patients, e.g., patient 12, associated with practitioner 60. For example, patient data 68 specifies general information, such as a name, birth date, and a dental history, for each patient 12.

Rendering engine 58 accesses and renders 3D data 66 to generate the 3D view presented to practitioner 60 by user interface 54. More specifically, 3D data 66 includes information defining the 3D objects that represent each tooth (optionally including roots), and jaw bone within the 3D environment. Rendering engine 58 processes each object to render a 3D triangular mesh based on viewing perspective of practitioner 60 within the 3D environment. User interface 54 displays the rendered 3D triangular mesh to practitioner 60, and allows practitioner 60 to change viewing perspectives and manipulate objects within the 3D environment.

U.S. Pat. No. 8,194,067, to Raby et al., which is incorporated by reference in its entirety, and U.S. Pat. No. 7,731,495, by Eisenberg, which is incorporated by reference in its entirety, describe other examples for computer systems and 3D modeling software having user interfaces that may be used with the techniques described herein.

Client computer 50 includes processor 72 and memory 74 to store and execute modeling software 52. Memory 74 may represent any volatile or non-volatile storage elements. Examples include random access memory (RAM) such as synchronous dynamic random access memory (SDRAM), read-only memory (ROM), non-volatile random access memory (NVRAM), electrically erasable programmable read-only memory (EEPROM), and FLASH memory. Examples may also include non-volatile storage, such as a hard-disk, magnetic tape, a magnetic or optical data storage media, a compact disk (CD), a digital versatile disk (DVD), a Blu-ray disk, and a holographic data storage media.

Processor 72 represents one or more processors such as a general-purpose microprocessor, a specially designed processor, an application specific integrated circuit (ASIC), a field programmable gate array (FPGA), a collection of discrete logic, or any type of processing device capable of executing the techniques described herein. In one example, memory 74 may store program instructions (e.g., software instructions) that are executed by processor 72 to carry out the techniques described herein. In other examples, the techniques may be executed by specifically programmed circuitry of processor 72. In these or other ways, processor 72 may be configured to execute the techniques described herein.

Client computer 50 is configured to send a digital representation of a 3D tooth structure of a patient, and optionally, treatment data 64 and/or patient data 68 to computer 80 of manufacturing facility 20 via network 24. Computer 80 includes user interface 82. User interface 82 provides a GUI that visually displays the 3D representation of the digital model of teeth. In addition, user interface 82 provides an interface for receiving input from a user, e.g., via a keyboard and a pointing device, for manipulating teeth of a patient within the digital representation of the 3D tooth structure of the patient.

Computer 80 may further be configured to automatically determine dimensions and shapes of each removable dental appliance of a set of removable dental appliances 22. The dimensions and shapes of removable dental appliance 22 may include a position, dimension, and shape (e.g., at least one of at least one position, at least one dimension, and at least one shape) of at least one of the plurality of shells, at least one bendable flap, at least one arcuate member, at least one reinforcing structure, and the like, such that removable dental appliance 22 is configured to reposition the one or more teeth from their initial positions to final positions when the removable dental appliance is worn by the patient. As discussed above with respect to FIGS. 1-17, the position, dimension, and shape of at least one of the plurality of shells (e.g., shells 104, 204, 304, 404, 504, 604, 704, 804, 904, 1004, 1104, 2004, 2104, 2204, 2304, 2404, or 2504), at least one bendable flap (e.g., bendable flaps 108C, 208, 308A, 308B, 408A, 408B, 508A, 508B, 608A, 608B, 608C, 608D, 708A, 708B, 708C, 708D, 808A, 808B, 808C, 908A, 908B, 1008, 1008A, 1108B, 2008, 2108, 2208, 2408, or 2508), at least one arcuate member (e.g., arcuate members 109C, 209, 309A, 309B, 409A, 409B, 509A, 509B, 609A, 609B, 609C, 609D, 709A, 709B, 709C, 709D, 809A, 809B, 809C, 909A, 909B, 1009, 1009A, 1109B, 2009, 2109, 2209, 2409, or 2509), at least one reinforcing structure (e.g., reinforcing structures 1005 or 1105), and the like may affect the magnitude, direction, and length of expression of a force applied to the teeth when the removable dental appliance is worn by the patient. For example, the position, dimensions, and shape of a respective bendable flap and/or arcuate member may determine, at least in part, the magnitude, direction, and length of expression of the force resulting from a deformation of the bendable flap and/or arcuate member when the removable dental appliance is worn by the patient. The position, dimensions, and shape of the arcuate member and/or an optional reinforcing structure may concentrate deformation in selected regions of a respective bendable flap to control the direction of force applied to the teeth. Also, the position, dimensions, and shape of a respective shell of the plurality of shells may affect the location(s) of engagement of a respective shell with a respective tooth. The location(s) of engagement may affect the direction of the force applied to the respective tooth. Computer 80 may analyze at least one of the magnitude, direction, and length of expression of at least one force resulting from a deformation of the respective bendable flap and/or arcuate member when the removable dental appliance is worn by the patient to determine at least one of position, dimension, and shape of a respective shell, a respective bendable flap, a respective arcuate member, a respective reinforcing structure, or the like that will result in a desired movement of a respective tooth of a patient when the removable dental appliance is worn by the patient.

Computer 80 may present a representation of the removable dental appliance 22 for user to review, including review of dimensions and shapes. Alternatively, or additionally, computer 80 may accept input from a user to determine dimensions and shapes of a set of removable dental appliances 22 for patient 12. For example, the user input may influence at least one of an automatically determined dimensions or shapes. Computer 80 may transmit, or otherwise send, a digital model of the set of removable dental appliance 22, the dimensions and shapes of the set of removable dental appliances 22, or both, to computer-aided manufacturing system 84 for production of the set of removable dental appliances 22.

Client computer 50 and computer 80 are merely conceptual representations of an example computer system. In some examples, the functionalities described with respect to client computer 50, computer 80, or both may be combined into a single computing device or distributed among multiple computing devices within a computer system. For example, cloud computing may be used for digital design of dental appliances described herein. In one example, the digital representations of tooth structures are received at one computer at the clinic, while a different computer, such as computer 80, is used to determine the shapes and dimensions of a removable dental appliance. In addition, it may not be necessary for that different computer, such as computer 80, to receive all of the same data in order for it determine shapes and dimensions. Shapes and dimensions may be determined, at least in part, based on knowledge derived through analysis of historical cases or virtual models of exemplary cases, without receiving a complete 3D representation of the case in question. In such an example, data transmitted between client computer 50 and computer 80, or otherwise utilized to design a custom dental appliance may be significantly less than the complete data set representing a complete digital dental model of a patient.

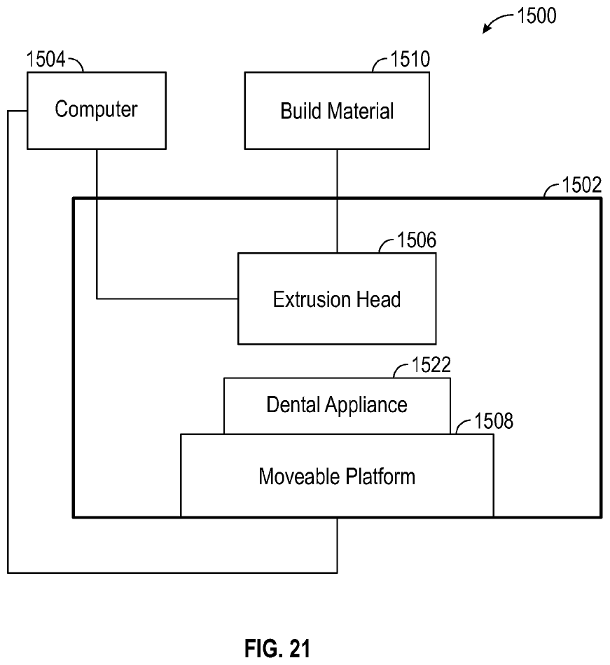

FIG. 21 is a block diagram illustrating an example computer-aided manufacturing system 1500 for construction of removable dental appliance 1522. The example of computer-aided manufacturing system 1500 includes an additive manufacturing system 1502 in communication with computer 1504 and coupled to build material source 1510. In some examples, computer-aided manufacturing system 1500 may include computer-aided manufacturing system 84 of FIG. 20. For example, computer 1504 may be the same as or substantially similar to computer 80. Build material source 1510 includes a source of at least one polymeric material, such as, for example, at least one of the polymeric materials of appliance body 102 discussed above. Dental appliance 1522 may be the same as or substantially similar to at least one of removable dental appliances 100, 200, 300, 400, 500, 600, 700, 800, 900, 1000, 1100, 2000, 2100, 2200, 2300, 2400, or 2500. In some examples, dental appliance 1522 includes one dental appliance of a set of dental appliances 22.

Additive manufacturing system 1502 includes a moveable platform 1508 and an extrusion head 1506. Movable platform 1508 and extrusion head 1506 are configured to manufacture dental appliance 1522. For example, computer 1504 controls extrusion head 1506 and moveable platform 1508 to manufacture removable dental appliance 1522. Controlling, by computer 1504, extrusion head 1506 may include at least one of controlling a material feed rate from build material source 1510 to extrusion head 1506, controlling a deposition rate of build material on dental appliance 1522, controlling a temperature of extrusion head 1506, and controlling a position of extrusion head 1506. By controlling at least one of a material feed rate, a material deposition rate, a temperature of extrusion head 1506, and a position of extrusion head 1510, computer 1504 may control manufacture of a position, dimension, and shape of at least a portion of dental appliance 1522. Controlling, by computer 1504, movable platform 1508 may include at least one of controlling a translation of moveable platform in a plane normal to the direction of material deposition from extrusion head 1506 and controlling an elevation of moveable platform along an axis substantially parallel to the direction of material deposition from extrusion head 1506. By controlling at least one of a translation and elevation of moveable platform 1508, computer 1504 may control manufacture of a position, dimension, and shape of at least a portion of dental appliance 1522.

Although FIG. 21 illustrates a computer-aided manufacturing system 1500 configured for Fused Deposition Modeling (FDM), computer-aided manufacturing system 1500 may also be configured for stereolithography (SLA), inverse vat polymerization additive manufacturing, inkjet/polyjet additive manufacturing, or other methods of additive manufacturing. In examples in which computer-aided manufacturing system 1500 is configured for polyjet printing, computer-aided manufacturing system 1500 may be configured to print multiple materials in a single print, thereby allowing a high modulus material for the rigid components of dental appliance 1522 (e.g., shells) and a low modulus or elastomeric material for the less rigid components of dental appliance 1522 (e.g., bendable flaps and/or arcuate members). Further, with polyjet additive manufacturing, the modulus may be varied selectively across the dental appliance 1522, and a different modulus may be used for the bendable flaps and/or arcuate members than is used for the shells, for different parts of a bendable flap and/or arcuate members, or for different parts of a shell, for example. Similarly, a different modulus may be used for the anchoring shells than is used for the shell used to reposition individual teeth.

Additionally, or alternatively, manufacturing a dental appliance may include thermoforming and using a femtosecond laser controlled by a multi-axis robot or CNC machine to cut away material, such as to form slots, hinges, and spring features. In some instances, cut depth may be controlled to selectively ablate material and reduce the thickness of the appliance in certain areas, such as to form a more flexible hinge axis or to increase the flexibility of a spring element.

Additionally, or alternatively, manufacturing a dental appliance may include forming at least a portion of the appliance, if not the entire appliance, by milling or otherwise machining the appliance from a solid block of material.

Additionally, or alternatively, manufacturing a dental appliance may include, especially where varying thickness or reinforcements are needed, thermoforming the appliance body, and using a multi-axis robot to dispense, via a heated extrusion nozzle, hot thermoplastic material onto an appliance of otherwise uniform thickness. This can serve to create structures of greater thickness in areas. In similar fashion, a photocurable resin may be dispensed onto the surface and light cured, either immediate after dispensing or after all features have been laid down.

Additionally, or alternatively, manufacturing a dental appliance may include, the prefabrication of bendable flaps and/or arcuate members. The prefabricated bendable flaps and/or arcuate members may include material such as stainless steel, titanium, or nickel titanium (NiTi), and bonded or fastened to the appliance body which is formed by other means, such as by thermoforming or 3D printing. The advantage in this approach is to allow for smaller structures having greater force delivery. In such cases, the computing device would be used to select from among a discrete set of premanufactured flaps the meet the required force and deflection criteria to achieve the prescribed movement, and place to determine the best position(s) for placement on each tooth.

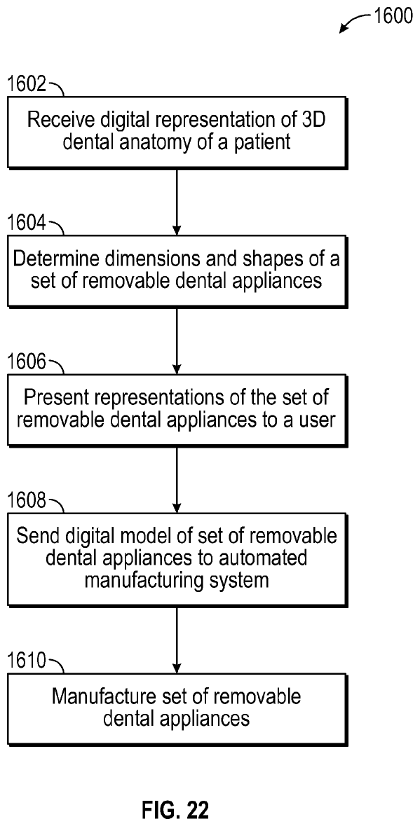

FIG. 22 is a flow diagram illustrating process 1600 conducted at manufacturing facility 20 for construction of set of removable dental appliances 22. In some examples, set of removable dental appliances 22 may include at least one of removable dental appliance 100, 200, 300, 400, 500, 600, 700, 800, 900, 1000, 1100, 2000, 2100, 2200, 2300, 2400, or 2500. Computer 80 at manufacturing facility 20 receives digital dental anatomy data 16 including initial positions of one or more teeth of the patient and prescription data 18 (1602) from clinic 14. Alternatively, computer 80 may retrieve the information from a database located within or otherwise accessible by computer 80. A trained user associated with computer 80 may interact with a computerized modeling environment running on computer 80 to develop a treatment plan relative to the digital representation of the patient's tooth structure and generate prescription data 18, if clinic 14 has not already done so. In other examples, computer 80 may automatically develop a treatment plan based solely on the patient's tooth structure and predefined design constraints.

Once computer 80 receives patient's tooth structure, computer 80 determines dimensions and shapes of a removable dental appliance for the patient (1604). The dimensions and shapes of the removable dental appliance are configured to reposition the one or more teeth of the patient from their initial positions to desired positions when the removable dental appliance is worn by the patient. In the same or additional examples, computer 80 determines dimensions and shapes of set of removable dental appliances 22 for the patient configured to be worn in series.

In some examples, determining dimensions and shapes of the removable dental appliance includes selecting, with computer 80, the dimensions and shapes of the removable dental appliance according to a set of predefined design constraints. The set of predesigned design constraints may include one or more factors, including, but not limited to, at least one of a minimum and a maximum localized force applied to one or more of the surrounded teeth, at least one of a minimum and a maximum rotational force applied to one or more of the surrounded teeth, at least one of a minimum and a maximum translational force applied to one or more of the surrounded teeth, at least one of a minimum and a maximum total force applied to one or more of the surrounded teeth, and at least one of a minimum and a maximum stress or strain applied to the removable dental appliance, when the removable dental appliance is worn by the patient and the surrounded teeth are in their initial positions.

Computer 80 may use finite element analysis (FEA) techniques to analyze forces on the teeth of a patient as well as the removable dental appliance during the determination of the dimensions and shapes of the removable dental appliance. For example, computer 80 may apply FEA to a solid model of the teeth of a patient as the modeled teeth move from their initial positions to their final positions representing a treatment including an ordered set of removable dental appliances. Computer 80 may use FEA to select the appropriate removable dental appliance to apply the desired forces on the teeth. In addition, computer 80 may use a virtual articulator to determine contact points between the teeth throughout the movement of the modeled teeth during the treatment. Computer 80 may further include occlusal contact forces, such as interdigitation forces, in the FEA forces analysis in combination with forces from the removable dental appliance during the design of dental appliances in an ordered set of removable dental appliances. Computer 80 may further determine an order in which teeth are to be moved to optimize the application of forces, reduce treatment time, improve patient comfort, or the like.

In some examples, determining dimensions and shapes of a removable dental appliance (e.g., removable dental appliance 100, 200, 300, 400, 500, 600, 700, 800, 900, 1000, 1100, 2000, 2100, 2200, 2300, 2400, or 2500) includes selecting, with computer 80 thicknesses of the appliance body (e.g., appliance body 102, 202, 302, 402, 502, 602, 702, 802, 902, 1002, and 1102), at least one of the plurality of shells (e.g., shells 104, 204, 304, 404, 504, 604, 704, 804, 904, 1004, 1104, 2004, 2104, 2204, 2304, 2404, or 2504), at least one bendable flap (e.g., bendable flaps 108C, 208, 308A, 308B, 408A, 408B, 508A, 508B, 608A, 608B, 608C, 608D, 708A, 708B, 708C, 708D, 808A, 808B, 808C, 908A, 908B, 1008, 1008A, 1108B, 2008, 2108, 2208, 2408, or 2508), at least one arcuate member (e.g., arcuate members 109C, 209, 309A, 309B, 409A, 409B, 509A, 509B, 609A, 609B, 609C, 609D, 709A, 709B, 709C, 709D, 809A, 809B, 809C, 909A, 909B, 1009, 1009A, 1109B, 2009, 2109, 2209, 2409, or 2509), at least one reinforcing structures (e.g., reinforcing structures 1005 or 1105), or the like, to provide a stiffness suitable to reposition the one or more teeth of the patient from their initial positions to final positions when the removable dental appliance is worn by the patient. In some examples, the selected thickness may range between about 0.10 millimeters and about 2.0 millimeters, such as between about 0.2 and about 1.0 millimeters, or between about 0.3 millimeters and about 0.75 millimeters. In some examples, computer 80 may further select a material of the removable dental appliance according to the predefined design constraints.

The dimensions and shapes of a removable dental appliance for the patient may be presented to a user via user interface of 82 of computer 80 (1606). In examples in which dimensions and shapes of the removable dental appliance are presented to a user via user interface of 82, the user may have the opportunity to adjust the design constraints or directly adjust the dimensions and shapes of removable dental appliance before the design data is sent to computer-aided manufacturing system 84. In some examples, the dimensions and shapes of the removable dental appliance may be presented to a user by computer 80 directly as the removable dental appliance is manufactured by computer-aided manufacturing system 84. For example, computer 80 may send a digital model of the removable dental appliance to computer-aided manufacturing system 84, and computer-aided manufacturing system 84 manufactures removable dental appliance according to the digital model from computer 80.

However, even in examples where the dimensions and shapes of a removable dental appliance for the patient may be presented to a user via user interface of 82 of computer 80, following user approval, computer 80 sends a digital model of the removable dental appliance to computer-aided manufacturing system 84 (1608), and computer-aided manufacturing system 84 manufactures the removable dental appliance according to the digital model from computer 80 (1610).

In some examples, computer-aided manufacturing system 84 may include a 3D printer. Forming appliance body (e.g., appliance body 102, 202, 302, 402, 502, 602, 702, 802, 902, 1002, and 1102) may include printing the surfaces of at least one of the plurality of shells (e.g., shells 104, 204, 304, 404, 504, 604, 704, 804, 904, 1004, 1104, 2004, 2104, 2204, 2304, 2404, or 2504), at least one bendable flap (e.g., bendable flaps 108C, 208, 308A, 308B, 408A, 408B, 508A, 508B, 608A, 608B, 608C, 608D, 708A, 708B, 708C, 708D, 808A, 808B, 808C, 908A, 908B, 1008, 1008A, 1108B, 2008, 2108, 2208, 2408, or 2508), at least one arcuate member (e.g., arcuate members 109C, 209, 309A, 309B, 409A, 409B, 509A, 509B, 609A, 609B, 609C, 609D, 709A, 709B, 709C, 709D, 809A, 809B, 809C, 909A, 909B, 1009, 1009A, 1109B, 2009, 2109, 2209, 2409, or 2509), at least one reinforcing structures (e.g., reinforcing structures 1005 or 1105), or the like with the 3D printer. In other examples, forming appliance body may include printing representations of the teeth of a patient (e.g., teeth 103) with the 3D printer, thermoforming appliance body over the representations of the teeth of a patient, and trimming excess material (optionally automated by CNC or robotic machinery such as, e.g., end mill or LASER cutter) to form the plurality of shells, at least one bendable flap, at least one arcuate member, at least one reinforcing structure, and like. The representations of the teeth of a patient may include raised surfaces to facilitate forming at least one of the plurality of shells, the at least one bendable flap, at least one arcuate member, at least one reinforcing structure, and the like, in the thermoformed and trimmed appliance body.

The techniques of FIG. 22 may be applied to design and manufacture of each of an ordered set of removable dental appliances 22. For example, each removable dental appliance in the ordered set of removable dental appliances 22 may be configured to incrementally reposition the teeth of the patient. In this manner, the ordered set of removable dental appliances 22 may be configured to reposition the teeth of the patient to a greater degree than any one of the removable dental appliances within the set of the removable dental appliances 22. Such an ordered set of removable dental appliances 22 may specifically be configured to incrementally reposition the one or more teeth of the patient from their initial positions to desired positions as the removable dental appliances of the ordered set of removable dental appliances 22 for the patient are worn sequentially by the patient.

In some examples, the techniques described with respect to FIG. 22 may be embodied within a computer-readable storage medium, such as a computer-readable storage medium of computer 50, computer 80, or both. The computer-readable storage medium may store computer-executable instructions that, when executed, configure a processor to perform the techniques described with respect to FIG. 22.

Following the design of set of removable dental appliances 22, manufacturing facility 20 fabricates set of removable dental appliances 22 in accordance with the digital dental anatomy data 16 and prescription data 18 (1610). Construction of removable dental appliances 22 may include 3D printing, thermoforming, injection molding, lost wax casting, 5-axis milling, laser cutting, hybrid plastic and metal manufacturing techniques, such as snap-fitting and overmolding, as well as other manufacturing techniques.

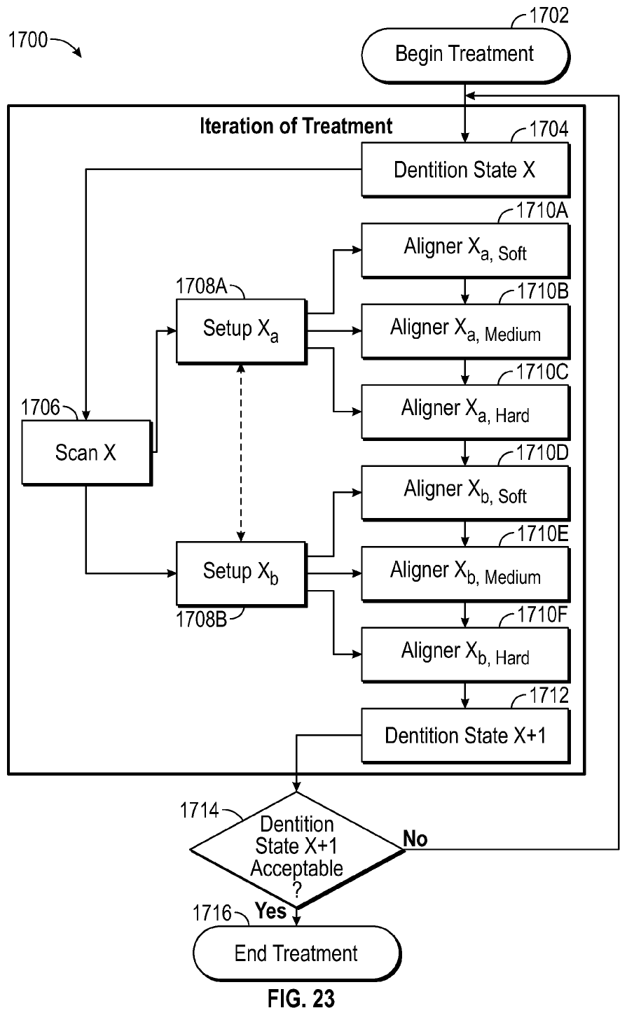

FIG. 23 is a flow diagram 1700 illustrating successive iterations of treatment using an ordered set of removable dental appliances. The ordered set of removable dental appliances is configured to reposition one or more teeth of a patient. In some examples, the ordered set of removable dental appliances may include at least one of removable dental appliances 100, 200, 300, 400, 500, 600, 700, 800, 900, 1000, 1100, 2000, 2100, 2200, 2300, 2400, or 2500.

Treatment begins with the first iteration of treatment (1702). At the beginning of the first iteration of treatment, the teeth of a patient are at their initial positions as represented by detention state X (1704). A scan of the teeth of a patient, for example, as described above with respect to FIG. 18, are taken to facilitate the design of the ordered set of removable dental appliances (1706). From the scan of teeth of a patient, a computer, e.g., computer 50, determines at least one, such as two, different shapes and dimensions for removable dental appliances in the ordered set: first setup Xₐ 1708A and second setup X_{b} 1708B. Example techniques for creating a digital model of the teeth of a patient are described in U.S. Pat. No. 8,738,165 to Cinader, et al., which is incorporated herein by reference in its entirety. The computer may determine first setup Xₐ 1708A and second setup X_{b} 1708B by first adjusting the digital model of the teeth of a patient to create a model of the desired position of the teeth of a patient following the therapy. Then, the computer may create the shape and dimensions for removable dental appliances in the ordered set based on the time and forces required to move the teeth of a patient from the initial positions to their desired positions. For example, the computer model may adjust the thicknesses, positions, shapes, and dimensions of at least one of the plurality of shells, at least one bendable flap, at least one reinforcing structure, and the like of the removable dental appliances in the ordered set to produce the forces required to move the teeth of a patient from the initial positions to the desired positions. The modeled forces applied by removable dental appliances in the ordered set may further be based on the incremental positional movements of the teeth of a patient during the treatment. In this manner, the computer may design each of the removable dental appliances in the ordered set according to expected forces applied on the teeth in the predicted positions of the teeth at the time during the treatment the removable dental appliances in the ordered set is to be worn by the patient.

In some examples, at least one, such as three, different removable dental appliances in the set of removable dental appliances can be manufactured using each of first setup Xₐ 1708A and second setup X_{b} 1708B to produce at least two, such as six, removable dental appliances in the set of removable dental appliances. For example, first setup Xₐ 1708A may be used to manufacture first removable dental appliance (RDA) X_{a, SOFT} 1710A, second RDA X_{a, MEDIUM} 1710B, and third RDA X_{a, HARD} 1710C; and second setup X_{b} 1708B may be used to manufacture fourth RDA X_{b, SOFT} 1710D, fifth RDA X_{b, MEDIUM} 1710E, and sixth RDA X_{b, HARD} 1710F. First, second, and third RDAs 1710A to 1710C may be substantially the same shape and dimensions, but may comprise materials with different stiffness characteristics. For example, the second and third RDAs 1710B and 1710C may have higher stiffness characteristics than first RDA 1710A, and third RDA 1710C may have higher stiffness characteristics than second RDA 1710B. Similarly, the fourth, fifth, and sixth RDAs 1710D to 1710F may be substantially the same shape and dimensions, but comprise materials with different stiffness characteristics. In some examples, first RDA 1710A may have the same stiffness characteristics as the fourth RDA 1710D, such as a relatively soft polymeric material. Similarly, second RDA 1710B may have the same stiffness characteristics as the fifth RDA 1710E, such as a relatively stiffer polymeric material than first RDA 1710A. Likewise, third RDA 1710C may have the same stiffness characteristics as the sixth RDA 1710F, such as a relatively stiffer polymeric material than second RDA 1710B.

RDAs 1710A to 1710F in the ordered set of removable dental appliances may be worn in sequence over time by the patient. For example, each of RDAs 1710A to 1710F in the ordered set of removable dental appliances may be worn between about 1 week and about 6 weeks, such as between about 2 weeks and about 4 weeks, or about 3 weeks. Following the treatment plan using RDAs 1710A to 1710F, the teeth of a patient may be at their final positions for the first iteration of treatment as represented by detention state X+1 (1712).

Once teeth of a patient are at or near dentition state X+1, the patient may return to the clinician who may evaluate the result of the first iteration of treatment (1714). If the first iteration of treatment has resulted in acceptable final positions of the teeth of a patient, then the treatment may be ended (1716). However, if the first iteration of treatment did not result in acceptable final positions of the teeth of a patient, one or more additional iterations of treatment may be performed. To begin the next iteration of treatment, the clinician may take another scan of the teeth of a patient to facilitate the design of a subsequent ordered set of removable dental appliances (1706). In some examples, evaluation of the result of the first iteration of treatment may include taking another scan of the teeth of a patient, in which case beginning the next iteration of treatment may simply involve forwarding the digital model of the teeth of a patient to a manufacturing facility so that another ordered set of removable dental appliances may be manufactured for the patient based on the new positions of the teeth of a patient. In yet other examples, the newly acquired scan may be used to create one or more iterations of removable dental appliances in the clinician's facility.

The techniques of FIG. 23 represent one specific example, and a variety of modifications may be made to the techniques of FIG. 23 within the spirit of this disclosure. For example, an ordered set of removable dental appliances may include more or less than six removable dental appliances. As another example, each removable dental appliance in the ordered set of removable dental appliances may have unique shapes and dimensions, and each removable dental appliance in the ordered set of removable dental appliances may be made of material having substantially the same or similar stiffness characteristics.

Various examples have been described. These and other examples are within the scope of the following claims.

1. A removable dental appliance comprising:
an appliance body configured to at least partially surround a plurality of teeth of a patient, the appliance body defining a shell configured to receive a tooth of the plurality of teeth in an initial position; and
a bendable flap integrally formed with the appliance body to extend from a hinge axis of the shell, wherein the bendable flap defines a flap boundary region extending from a first end of the hinge axis around the bendable flap to a second end of the hinge axis, and wherein the boundary region comprises an arcuate member,
wherein the bendable flap and the arcuate member are configured to apply a force to the tooth to cause movement of the tooth toward a desired position when the removable dental appliance is worn by the patient.

2. The removable dental appliance of claim 1, wherein the arcuate member comprises a spring bellows extending away from a plane of the shell.

3. The removable dental appliance of claim 2, wherein a thickness of the spring bellows is less than a thickness of the shell to at least one of concentrate strain in the at least one spring bellows or reduce deformation of the first shell and the second shell when the removable dental appliance is worn by the patient.

4. The removable dental appliance of claim 2, wherein a thickness of the spring bellows varies along the flap boundary region.

5. The removable dental appliance of claim 2, wherein an outer radius of curvature of the spring bellows varies along the flap boundary region.

6. The removable dental appliance of claim 2, wherein the spring bellows defines a shear reduction region.

7. The removable dental appliance of claim 2, wherein the spring comprises a plurality of spring bellows, wherein each respective spring bellows of the plurality of spring bellows is disposed along a respective portion of the flap boundary region.

8. The removable dental appliance of claim 2, the spring bellows comprises at least one of an arc, zig-zag, sinusoid, a pulsed wave, or serpentine shape.

9. The removable dental appliance of claim 1, wherein the arcuate member comprises a jumper comprising an elongated structure extending between a first end coupled to the shell and a second end coupled to the bendable flap.

10. (canceled)

11. The removable dental appliance of claim 9, wherein the jumper comprises at least one of an arc, zig-zag, sinusoid, spiral, helix, or serpentine shape extending between the first end and the second end of the jumper.

12. The removable dental appliance of claim 9, wherein the jumper defines a cross-section in a plane perpendicular to a longitudinal axis of the elongated structure of the jumper, and wherein the shape, area, or aspect ratio of the cross-section varies along the longitudinal axis.

13. The removable dental appliance of claim 9, wherein the jumper is under a bending stress or a twisting stress when the removable dental appliance is worn by the patient.

14-15. (canceled)

16. The removable dental appliance of claim 9, wherein the jumper comprises a plurality of jumpers, wherein each respective jumper of the plurality of jumpers comprises a respective elongated structure extending between a respective first end coupled to a respective position on the shell and a respective second end coupled to a respective position on the bendable flap.

17. The removable dental appliance of claim 1,
wherein the shell comprises an internal surface that defines a void internal to the shell and shaped to receive the tooth in the desired position, and
wherein the bendable flap and the arcuate member are configured to apply the force to a side of the tooth opposite from the void to cause movement of the tooth toward the void.

18. The removable dental appliance of claim 17, wherein the internal surface of the shell further defines a second portion of the void, wherein the removable dental appliance further comprises a second bendable flap integrally formed with the appliance body to extend from a second hinge axis of the shell, wherein the second bendable flap defines a second boundary region extending from a first end of the second hinge axis around the second bendable flap to a second end of the second hinge axis, wherein the second boundary region comprises a second arcuate member, and wherein the second bendable flap and the second arcuate member are configured to apply a second force to a second side of the tooth opposite from the second portion of the void to cause movement of the tooth toward the second portion of the void.

19. The removable dental appliance of claim 1,
wherein a rest position of the bendable flap intrudes into a space defined by the tooth in the desired position of the tooth, and
wherein the bendable flap is displaced into a deformed position to cause the force when the removable dental appliance is worn by the patient.

20. (canceled)

21. A system comprising an ordered set of removable dental appliances configured to reposition one or more teeth of a patient, at least one removable dental appliance in the set of removable dental appliances comprising the removable dental appliance of claim 1.

22. A method comprising:
receiving, by a computing device, a digital representation of a three-dimensional (3D) dental anatomy of a patient, the dental anatomy providing initial positions of a plurality of teeth of the patient;
determining, by the computing device, dimensions and shapes of a removable dental appliance comprising the removable dental appliance of claim 1,
wherein the dimensions and shapes are configured to reposition the one or more teeth of the patient from an initial position to a desired position when the removable dental appliance is worn by the patient, and wherein the dimensions and shapes comprise:
a position, dimension, and shape of the shell;
a position, dimension, and shape of the bendable flap; and
a position, dimension, and shape of the arcuate member; and
transmitting, by the computing device, a representation of the removable dental appliance to a computer-aided manufacturing system.

23-24. (canceled)

25. The method of claim 22, wherein determining, by the computing device, dimensions and shapes of the removable dental appliance includes selecting, by the computing device, the dimensions and shapes of the removable dental appliance according to a set of predefined design constraints, the set of predefined design constraints including one or more of a group consisting of:
a minimum and a maximum localized force applied to the one or more teeth of the patient or the bendable flap when the removable dental appliance is worn by the patient;
a minimum and a maximum rotational force applied to the one or more teeth of the patient or the bendable flap when the removable dental appliance is worn by the patient;
a minimum and a maximum translational force applied to the one or more teeth of the patient or the bendable flap when the removable dental appliance is worn by the patient;
a minimum and a maximum total force applied to the one or more teeth of the patient or the bendable flap when the removable dental appliance is worn by the patient; and
a minimum and a maximum strain applied to the removable dental appliance when worn by the patient.
